(19) United States
(12) Patent Application Publication
(10) Pub. No.: US 2019/0025950 A1
(43) Pub. Date: Jan. 24, 2019

(54) USER INTERFACE APPARATUS AND METHOD FOR USER TERMINAL

(71) Applicant: Samsung Electronics Co., Ltd., Suwon-si (KR)

(72) Inventors: Hwa-Kyung KIM, Seoul (KR); Jin-Ha JUN, Seoul (KR); Sung-Soo KIM, Bucheon-si (KR); Joo-Yoon BAE, Seoul (KR); Sang-Ok CHA, Daegu (KR)

(21) Appl. No.: 16/138,365

(22) Filed: Sep. 21, 2018

Related U.S. Application Data
(63) Continuation of application No. 13/862,762, filed on Apr. 15, 2013.

(30) Foreign Application Priority Data
Jul. 13, 2012 (KR) 10-2012-0076514
Dec. 4, 2012 (KR) 10-2012-0139927

(51) Int. Cl. G06F 3/0354; G06K 9/20; G06K 9/00; H04M 1/725; G06K 9/22; G06F 17/24

(52) U.S. Cl. CPC G06F 3/03545; G06K 9/2081; G06K 9/2063; G06K 9/00416; H04M 1/72519; G06F 3/04883; G06K 9/222; G06K 9/2054; G06F 17/242

(57) ABSTRACT

A handwriting-based User Interface (UI) apparatus in a user terminal supporting a handwriting-based memo function and a method for supporting the same are provided, in which upon receipt of a handwritten input on a memo screen from a user, the handwritten input is recognized, a command is determined from the recognized input, and an application corresponding to the determined command is executed.

### CROSS-REFERENCE TO RELATED APPLICATION(S)

This application is a continuation application of prior application Ser. No. 13/862,762, filed on Apr. 15, 2013, which was based on and claimed priority under 35 U.S.C. § 119(a) to a Korean patent application filed on Jul. 13, 2012 in the Korean Intellectual Property Office and assigned Serial No. 10-2012-0076514 and a Korean patent application filed on Dec. 4, 2012 in the Korean Intellectual Property Office and assigned Serial No. 10-2012-0139927, the entire disclosure of which are hereby incorporated by reference.

### BACKGROUND OF THE INVENTION

### 1. Field of the Invention

The present invention relates to a User Interface (UI) apparatus and method for a user terminal. More particularly, the present invention relates to a handwriting-based UI apparatus in a user terminal and a method for supporting the same.

### 2. Description of the Related Art

Along with the recent growth of portable electronic devices, the demand for User Interfaces (UIs) that enable intuitive input/output are on the increase. For example, traditional UIs on which information is input by means of an additional device such as a keyboard, a keypad, a mouse, and the like have evolved to intuitive UIs on which information is input by directly touching a screen with a finger or a touch electronic pen or by voice.

In addition, UI technology has been developed to be intuitive and human-centered as well as user-friendly. With the UI technology, a user can talk to a portable electronic device by voice so as to input intended information or obtain desired information.

Typically, a number of applications are installed and new functions are available from the installed applications in a popular portable electronic device, smart phone.

However, a plurality of applications installed in the smart phone are generally executed independently, and do not provide a new function or result to a user in conjunction with one another.

For example, a scheduling application allows input of information only through the application's own supported UI despite the user terminal supporting an intuitive UI.

Moreover, a user terminal supporting a memo function enables a user to writes down notes using input means such as his or her finger or an electronic pen, but does not offer any specific method for utilizing the notes in conjunction with other applications.

The above information is presented as background information only to assist with an understanding of the present disclosure. No determination has been made, and no assertion is made, as to whether any of the above might be applicable as prior art with regard to the present invention.

### SUMMARY OF THE INVENTION

Aspects of the present invention are to address at least the above-mentioned problems and/or disadvantages and to provide at least the advantages described below. Accordingly, an aspect of the present invention is to provide an apparatus and method for exchanging information with a user on a handwriting-based User Interface (UI) in a user terminal.

Another aspect of the present invention is to provide a UI apparatus and method for executing a specific command using a handwriting-based memo function in a user terminal.

Another aspect of the present invention is to provide a UI apparatus and method for exchanging questions and answers with a user by a handwriting-based memo function in a user terminal.

Another aspect of the present invention is to provide a UI apparatus and method for receiving a command to process a selected whole or part of a note written on a screen by a memo function in a user terminal.

Another aspect of the present invention is to provide a UI apparatus and method for supporting switching between memo mode and command processing mode in a user terminal supporting a memo function through an electronic pen.

Another aspect of the present invention is to provide a UI apparatus and method for, while an application is activated, enabling input of a command to control the activated application or another application in a user terminal.

Another aspect of the present invention is to provide a UI apparatus and method for analyzing a memo pattern of a user and determining information input by a memory function, taking into account the analyzed memo pattern in a user terminal.

In accordance with an aspect of the present invention, a UI method in a user terminal is provided. The method includes receiving a pen input event according to a pen input applied on a memo screen by a user, recognizing pen input content according to the pen input event, determining, from the recognized pen input content, a command and note content for which the command should be executed, executing an application corresponding to the determined command, and providing the determined note content as input data for the application.

In accordance with another aspect of the present invention, a UI apparatus at a user terminal is provided. The apparatus includes a touch panel unit for displaying a memo screen and for outputting a pen input event according to a pen input applied on the memo screen by a user, a command processor for recognizing pen input content according to the pen input event, for determining a command and note content for which the command should be executed from the recognized pen input content, and for providing the command and the note content for which the command should be executed, and an application executer for executing an application corresponding to the determined command and for providing the determined note content as input data for the application.

In accordance with another aspect of the present invention, a UI apparatus at a user terminal is provided. The apparatus includes a touch screen for displaying a memo screen, and a controller for displaying a first application being executed on the touch screen, for receiving and displaying a first handwriting image corresponding to a command for executing a second application different from the first application on the touch screen, for displaying text asking for additional information about the first handwriting image on the touch screen in response to the first handwriting image, for receiving and displaying a second handwriting image corresponding to an input data for executing the second application on the touch screen in response to the text, for executing a function of the second application using the input data according to recognized results of the first and second handwriting images, and for displaying a result of the function execution on the touch screen.

In accordance with another aspect of the present invention, a UI apparatus at a user terminal is provided. The apparatus includes a touch screen for displaying a memo screen, and a controller for displaying a first application being executed on the touch screen, for receiving and displaying a first handwriting image requesting search on the touch screen, for displaying text asking for additional information about the first handwriting image on the touch screen in response to the first handwriting image, for receiving and displaying a second handwriting image corresponding to the additional information on the touch screen in response to the text, for searching for content by executing a search application according to recognized results of the first and second handwriting images, and for displaying a search result on the touch screen.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following detailed description taken in conjunction with the accompanying drawings, in which:

FIG. 1 is a schematic block diagram of a user terminal supporting handwriting-based Natural Language Interaction (NLI) according to an exemplary embodiment of the present invention;

FIG. 2 is a detailed block diagram of a user terminal supporting handwriting-based NLI according to an exemplary embodiment of the present invention;

FIG. 3 illustrates a configuration of a touch pen supporting handwriting-based NLI according to an exemplary embodiment of the present invention;

FIG. 4 illustrates an operation for recognizing a touch input and a pen touch input through a touch panel and a pen recognition panel according to an exemplary embodiment of the present invention;

FIG. 5 is a detailed block diagram of a controller in a user terminal supporting handwriting-based NLI according to an exemplary embodiment of the present invention;

FIG. 6 is a block diagram of a command processor for supporting handwriting-based NLI in a user terminal according to an exemplary embodiment of the present invention;

FIG. 7 is a flowchart illustrating a control operation for supporting a User Interface (UI) using handwriting-based NLI in a user terminal according to an exemplary embodiment of the present invention;

FIG. 8 illustrates an example of requesting an operation based on a specific application or function by a memo function according to an exemplary embodiment of the present invention;

FIG. 9 illustrates an example of a user's actual memo pattern for use according to an exemplary embodiment of the present invention;

FIG. 10 illustrates an example in which one symbol may be interpreted as various meanings according to an exemplary embodiment of the present invention;

FIG. 11 illustrates an example in which input information including text and a symbol in combination may be interpreted as different meanings depending on the symbol according to an exemplary embodiment of the present invention;

FIG. 12 illustrates examples of utilizing signs and symbols in semiotics according to an exemplary embodiment of the present invention;

FIG. 13 illustrates examples of utilizing signs and symbols in mechanical/electrical/computer engineering and chemistry according to an exemplary embodiment of the present invention;

FIGS. 14, 15, 16A and 16B, 17A and 17B, 18A and 18B, 19A, 19B, and 19C, 20, 21A and 21B, and 22 illustrate operation scenarios of a UI technology according to an exemplary embodiment of the present invention;

FIGS. 23, 24, 25, 26, 27, and 28 illustrate exemplary scenarios of launching an application supporting a memo function after a specific application is activated and then executing the activated application by the launched application according to an exemplary embodiment of the present invention; and

FIGS. 29 and 30 illustrate exemplary scenarios related to semiotics according to an exemplary embodiment of the present invention.

Throughout the drawings, like reference numerals will be understood to refer to like parts, components, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding, but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but are merely used by the inventor to enable a clear and consistent understanding of the invention. Accordingly, it should be apparent to those skilled in the art that the following description of exemplary embodiments of the present invention is provided for illustration purposes only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Exemplary embodiments of the present invention are described. For the convenience of description, defined entities may have the same names, to which exemplary embodiments the present invention is not limited. Thus, exemplary embodiments of the present invention can be implemented with the same or ready modifications in a system having a similar technical background.

Exemplary embodiments of the present invention described below are intended to enable a question and answer procedure with a user by a memo function in a user terminal to which handwriting-based User Interface (UI) technology is applied through Natural Language Interaction (NLI) (handwriting-based NLI′).

NLI generally involves understanding and creation. With the understanding and creation functions, a computer understands an input and displays text readily understandable to humans. Thus, it can be said that NLI is an application of natural language understanding that enables a dialogue in a natural language between a human being and an electronic device.

For example, a user terminal executes a command received from a user or acquires information required to execute the input command from the user in a question and answer procedure through NLI.

To apply handwriting-based NLI to a user terminal, switching should be performed organically between a memo mode and a command processing mode through handwriting-based NLI in the present invention. In the memo mode, a user writes down a note on a screen displayed by an activated application with input means such as a finger or an electronic pen in a user terminal, whereas in the command processing mode, a note written in the memo mode is processed in conjunction with information associated with a currently activated application.

For example, switching may occur between the memo mode and the command processing mode by pressing a button of an electronic pen (i.e., by generating a signal in hardware).

While the following description is given in the context of an electronic pen being used as a major input tool to support a memo function, exemplary embodiments of the present invention is not limited to a user terminal using an electronic pen as input means. It is to be understood that any device capable of inputting information on a touch panel may be used as input means according to the exemplary embodiments of the present invention.

Information is shared between a user terminal and a user in a preliminary mutual agreement so that the user terminal may receive intended information from the user by exchanging a question and an answer with the user and thus may provide the result of processing the received information to the user through the handwriting-based NLI according to exemplary embodiments of the present invention. For example, it may be agreed that in order to request operation mode switching, at least one of a symbol, a pattern, text, and a combination thereof is used or a motion (or gesture) is used by a gesture input recognition function. Memo mode to command processing mode switching or command processing mode to memo mode switching may be mainly requested.

In regard to agreement on input information corresponding to a symbol, a pattern, text, or a combination, user's memo pattern may be analyzed and the analysis result considered, to thereby enable a user to intuitively input intended information.

Various scenarios in which while a currently activated application is controlled by a memo function based on handwriting-based NLI and the control result is output are described below as separate exemplary embodiments of the present invention.

For example, a detailed description will be given of a scenario of selecting all or a part of a note and processing the selected note content by a specific command, a scenario of inputting specific information to a screen of a specific application by a memo function, a scenario of processing a specific command in a question and answer procedure using handwriting-based NLI, etc.

Reference will be made to preferred exemplary embodiments of the present invention with reference to the attached drawings. Detailed descriptions of a generally known function and structure will be avoided lest to prevent obscuring the subject matter of the present invention.

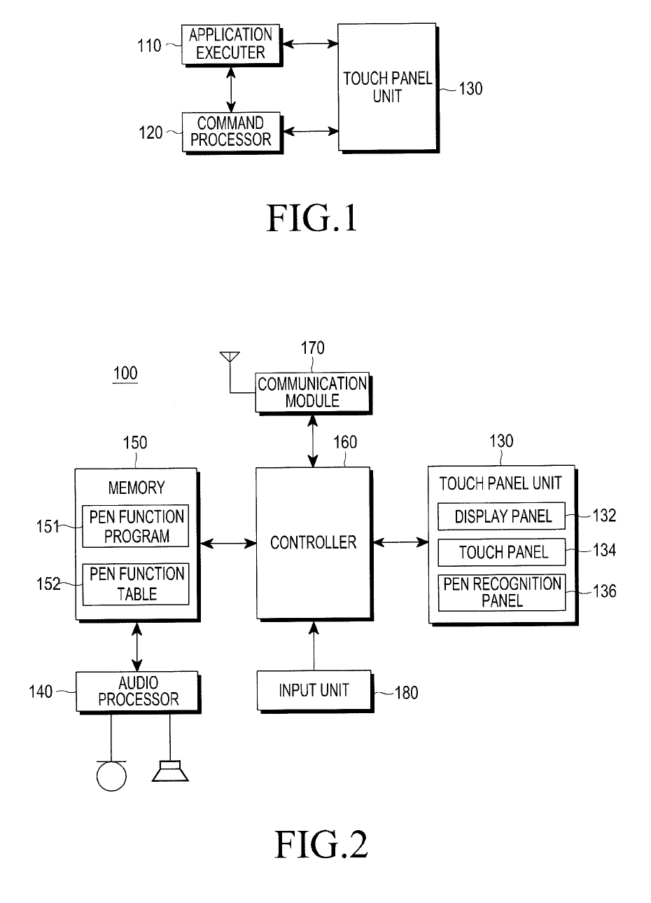

FIG. 1 is a schematic block diagram of a user terminal supporting handwriting-based NLI according to an exemplary embodiment of the present invention. While only components of the user terminal required to support handwriting-based NLI according to an exemplary embodiment of the present invention are shown in FIG. 1, components may be added to the user terminal in order to perform other functions. It is also possible to configure each component illustrated in FIG. 1 in the form of a software function block as well as a hardware function block.

Referring to FIG. 1, an application executer 110 installs an application received through a network or an external interface in conjunction with a memory (not shown), upon user request. The application executer 110 activates an installed application upon user request or in response to reception of an external command and controls the activated application according to an external command. The external command refers to almost any of externally input commands other than internally generated commands.

For example, the external command may be a command corresponding to information input through handwriting-based NLI by the user as well as a command corresponding to information input through a network. For sake of convenience, the external command is limited to a command corresponding to information input through handwriting-based NLI by a user, which should not be construed as limiting the present invention.

The application executer 110 provides the result of installing or activating a specific application to the user through handwriting-based NLI. For example, the application executer 110 outputs the result of installing or activating a specific application or executing a function of the specific application on a display of a touch panel unit 130.

The touch panel unit 130 processes input/output of information through handwriting-based NLI. The touch panel unit 130 performs a display function and an input function. The display function generically refers to a function of displaying information on a screen and the input function generically refers to a function of receiving information from a user.

However, the user terminal may include an additional structure for performing the display function and the input function. For example, the user terminal may further include a motion sensing module for sensing a motion input or an optical sensing module for sensing an optical character input. The motion sensing module may include a camera and a proximity sensor and may sense movement of an object within a specific distance from the user terminal using the camera and the proximity sensor. The optical sensing module may sense light and output a light sensing signal. For sake of convenience, it is assumed that the touch panel unit 130 performs both the display function and the input function without its operation being separated into the display function and the input function.

The touch panel unit 130 receives specific information or a specific command from the user and provides the received information or command to the application executer 110 and/or a command processor 120. The information may be information about a note written by the user (i.e., a note handwritten on a memo screen by the user) or information about an answer in a question and answer procedure based on handwriting-based NLI. The information may also be information for selecting all or part of a note displayed on a current screen.

The command may be a command requesting installation of a specific application or a command requesting activation or execution of a specific application from among already installed applications. The command may also be a command requesting execution of a specific operation, function, etc. supported by a selected application.

The information or command may be input in the form of a line, a symbol, a pattern, or a combination thereof, as well as in text. Such a line, symbol, pattern, etc. may be preset by an agreement or learning.

The touch panel unit 130 displays the result of activating a specific application or performing a specific function of the activated application by the application executer 110 on a screen.

The touch panel unit 130 also displays a question or result in a question and answer procedure on a screen. For example, when the user inputs a specific command, the touch panel unit 130 displays the result of processing the specific command received from the command processor 120, or a question to acquire additional information required to process the specific command. Upon receipt of the additional information as an answer to the question from the user, the touch panel unit 130 provides the received additional information to the command processor 120.

Subsequently, the touch panel unit 130 displays an additional question to acquire other information upon request of the command processor 120 or the result of processing the specific command, reflecting the received additional information.

The touch panel unit 130 displays a memo screen and outputs a pen input event according to a pen input applied on the memo screen by a user.

The command processor 120 receives the pen input event, for example a user-input text, symbol, figure, pattern, and the like from the touch panel unit 130 and identifies a user-intended input by the text, symbol, figure, pattern, and the like. For example, the command processor 120 receives a note written on a memo screen by the user from the touch panel unit 130 and recognizes the content of the received note. The command processor recognizes pen input content according to the pen input event.

For example, the command processor 120 may recognize the user-intended input by natural language processing of the received text, symbol, figure, pattern, etc. For the natural language processing, the command processor 120 employs handwriting-based NLI. The user-intended input includes a command requesting activation of a specific application or execution of a specific function in a current active application, or an answer to a question.

When the command processor 120 determines that the user-intended input is a command requesting a certain operation, the command processor 120 processes the determined command. The command processor 120 outputs a recognized result corresponding to the determined command to the application executer 110. The application executer 110 may activate a specific application or execute a specific function in a current active application based on the recognition result. In this case, the command processor 120 receives a processed result from the application executer 110 and provides the processed result to the touch panel unit 130. The application executer 110 may also provide the processed result directly to the touch panel unit 130, not to the command processor 120.

If additional information is needed to process the determined command, the command processor 120 creates a question to acquire the additional information and provides the question to the touch panel unit 130. Then the command processor 120 may receive an answer to the question from the touch panel unit 130.

The command processor 120 may continuously exchange questions and answers with the user, (i.e., may continue a dialogue with the user) through the touch panel unit 130 until acquiring sufficient information to process the determined command. The command processor 120 may repeat the question and answer procedure through the touch panel unit 130.

To perform the above-described operation, the command processor 120 adopts handwriting-based NLI by interworking with the touch panel unit 130. The command processor 120 enables questions and answers, a dialogue between a user and an electronic device by a memo function through a handwriting-based natural language interface. The user terminal processes a user command or provides the result of processing the user command to the user in the dialogue.

The user terminal may include other components in addition to the command processor 120, the application executer 110, and the touch panel unit 130. The command processor 120, the application executer 110, and the touch panel unit 130 may be configured according to various exemplary embodiments of the present invention.

For example, the command processor 120 and the application executer 110 may be incorporated into a controller 160 that provides overall control to the user terminal, or the controller 160 may be configured so as to perform the operations of the command processor 120 and the application executer 110.

The touch panel unit 130 is responsible for processing information input/output involved in applying handwriting-based NLI. The touch panel unit 130 may include a display panel for displaying output information of the user terminal and an input panel on which the user applies an input. The input panel may be implemented into at least one panel capable of sensing various inputs, such as a user's single-touch or multi-touch input, drag input, handwriting input, drawing input, and the like.

The input panel may be configured to include a single panel capable of sensing both a finger input and a pen input or two panels, for example, a touch panel capable of sensing a finger input and a pen recognition panel capable of sensing a pen input.

FIG. 2 is a detailed block diagram of a user terminal supporting handwriting-based NLI according to an exemplary embodiment of the present invention.

Referring to FIG. 2, a user terminal 100 according to an exemplary embodiment of the present invention may include a touch panel unit 130, an audio processor 140, a memory 150, a controller 160, a communication module 170, and an input unit 180.

The touch panel unit 130 may include a display panel 132, a touch panel 134, and a pen recognition panel 136. The touch panel unit 130 may display a memo screen on the touch panel 132 and receive a handwritten note written on the memo screen by the user through at least one of the touch panel 134 and the pen recognition panel 136. For example, upon sensing a touch input of a user's finger or an object in touch input mode, the touch panel unit 130 may output a touch input event through the touch panel 134. Upon sensing a pen input corresponding to a user's manipulation of a pen in pen input mode, the touch panel unit 130 may output a pen input event through the pen recognition panel 136.

Regarding sensing a user's pen input through the pen recognition panel 136, the user terminal 100 collects pen state information about a touch pen 20 and pen input recognition information corresponding to a pen input gesture through the pen recognition panel 136. Then the user terminal 100 may identify a predefined pen function command mapped to the collected pen state information and pen recognition information and executes a function corresponding to the pen function command. In addition, the user terminal 100 may collect information about the function type of a current active application as well as the pen state information and the pen input recognition information and may generate a predefined pen function command mapped to the pen state information, pen input recognition information, and function type information.

For the purpose of pen input recognition, the pen recognition panel 136 may be disposed at a predetermined position of the user terminal 100 and may be activated upon generation of a specific event or by default. The pen recognition panel 136 may be prepared over a predetermined area under the display panel 132, for example, over an area covering the display area of the display panel 132. The pen recognition panel 136 may receive pen state information according to approach of the touch pen 20 and a manipulation of the touch pen 20 and may provide the pen state information to the controller 160. The pen recognition panel 143 may receive pen input recognition information according to an input gesture made with the touch pen 20 and provide the pen input recognition information to the controller 160.

The pen recognition panel 136 is configured so as to receive a position value of the touch pen 20 based on electromagnetic induction with the touch pen 20 having a coil. The pen recognition panel 136 may collect an electromagnetic induction value corresponding to the proximity of the touch pen 20 and provide the electromagnetic induction value to the controller 160. The electromagnetic induction value may correspond to pen state information, (i.e., information indicating whether the touch pen is a hovering state or a contact state). The touch pen 20 hovers over the pen recognition panel 136 or the touch panel 134 by a predetermined gap in the hovering state, whereas the touch pen 20 contacts the display panel 132 or the touch panel 134 or is apart from the display panel 132 or the touch panel 134 by another predetermined gap in the contact state.

The configuration of the touch pen 20 is described below.

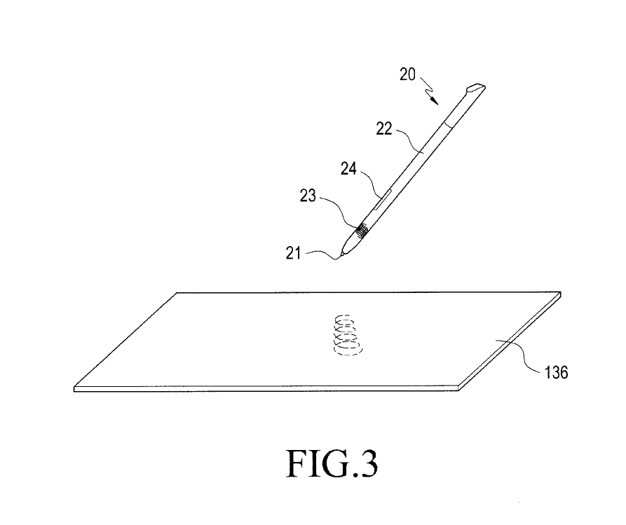

FIG. 3 illustrates a configuration of a touch pen for supporting handwriting-based NLI according to an exemplary embodiment of the present invention.

Referring to FIG. 3, the touch pen 20 may include a pen body 22, a pen point 21 at an end of the pen body 22, a coil 23 disposed inside the pen body 22 in the vicinity of the pen point 21, and a button 24 for changing an electromagnetic induction value generated from the coil 23. The touch pen 20 having this configuration supports electromagnetic induction. The coil 23 forms a magnetic field at a specific point of the pen recognition panel 136 so that the pen recognition panel 136 may recognize the touched point by detecting the position of the magnetic field.

The pen point 21 contacts the display panel 132, or the pen recognition panel 136 when the pen recognition panel 136 is disposed on the display panel 132, to thereby indicate a specific point on the display panel 132. Because the pen point 21 is positioned at the end tip of the pen body 22 and the coil 23 is apart from the pen point 21 by a predetermined distance, when the user writes with the touch pen 20, the distance between the touched position of the pen point 21 and the position of a magnetic field generated by the coil 23 may be compensated. Owing to the distance compensation, the user may perform an input operation such as handwriting (writing down) or drawing, touch (selection), touch and drag (selection and then movement), and the like, while indicating a specific point of the display panel 132 with the pen point 21. The user may apply a pen input including specific handwriting or drawing, while touching the display panel 132 with the pen point 21.

When the touch pen 20 comes within a predetermined distance to the pen recognition panel 136, the coil 36 may generate a magnetic field at a specific point of the pen recognition panel 136. Thus the user terminal 100 may scan the magnetic field formed on the pen recognition panel 136 in real time or at every predetermined interval. The moment the touch pen 20 is activated, the pen recognition panel 136 may be activated. The pen recognition panel 136 may recognize a different pen state according to the proximity of the pen 20 to the pen recognition panel 136.

The user may press the button 24 of the touch pen 20. As the button 24 is pressed, a specific signal may be generated from the touch pen 20 and provided to the pen recognition panel 136. For this operation, a specific capacitor, an additional coil, or a specific device for causing a variation in electromagnetic induction may be disposed in the vicinity of the button 24. When the button 24 is touched or pressed, the capacitor, additional coil, or specific device may be connected to the coil 23 and thus change an electromagnetic induction value generated from the pen recognition panel 136, so that the pressing of the button 24 may be recognized. Alternatively, the capacitor, additional coil, or specific device may generate a wireless signal corresponding to pressing of the button 24 and provide the wireless signal to a receiver (not shown) provided in the user terminal 100, so that the user terminal 100 may recognize the pressing of the button 24 of the touch pen 20.

As described above, the user terminal 100 may collect different pen state information according to a different displacement of the touch pen 20. The user terminal 100 may receive information indicating whether the touch pen 20 is in the hovering state or the contact state and information indicating whether the button 24 of the touch pen 20 has been pressed or is kept in its initial state. The user terminal 100 may determine a specific handwritten command based on pen state information received from the touch pen 20 and pen input recognition information corresponding to a pen input gesture received from the coil 23 of the touch pen 20 and may execute a function corresponding to the determined command.

Referring back to FIG. 2, when the touch pen 20 is positioned within a first distance (a predetermined contact distance) from the pen recognition panel 136, the pen recognition panel 136 may recognize that the touch pen 20 is in the contact state. If the touch pen 20 is apart from the pen recognition panel 136 by a distance falling within a range between the first distance and a second distance (a predetermined proximity distance), the pen recognition panel 136 may recognize that the touch pen 20 is in the hovering state. If the touch pen 20 is positioned beyond the second distance from the pen recognition panel 136, the pen recognition panel 136 may recognize that the touch pen 20 is in an air state. In this manner, the pen recognition panel 136 may provide different pen state information according to the distance to the touch pen 20.

Regarding sensing a user's touch input through the touch panel 134, the touch panel 134 may be disposed on or under the display panel 132. The touch panel 134 provides information about a touched position and a touch state according to a variation in capacitance, resistance, or voltage caused by a touch of an object to the controller 160. The touch panel 134 may be arranged in at least a part of the display panel 132. The touch panel 134 may be activated simultaneously with the pen recognition panel 136, or the touch panel 134 may be deactivated when the pen recognition panel 136 is activated, according to an operation mode. The touch panel 134 is activated simultaneously with the pen recognition panel 136 in simultaneous mode. In the pen input mode, the pen recognition module 136 is activated, whereas the touch panel 134 is deactivated. In the touch input mode, the touch panel 134 is activated, whereas the pen recognition panel 136 is deactivated.

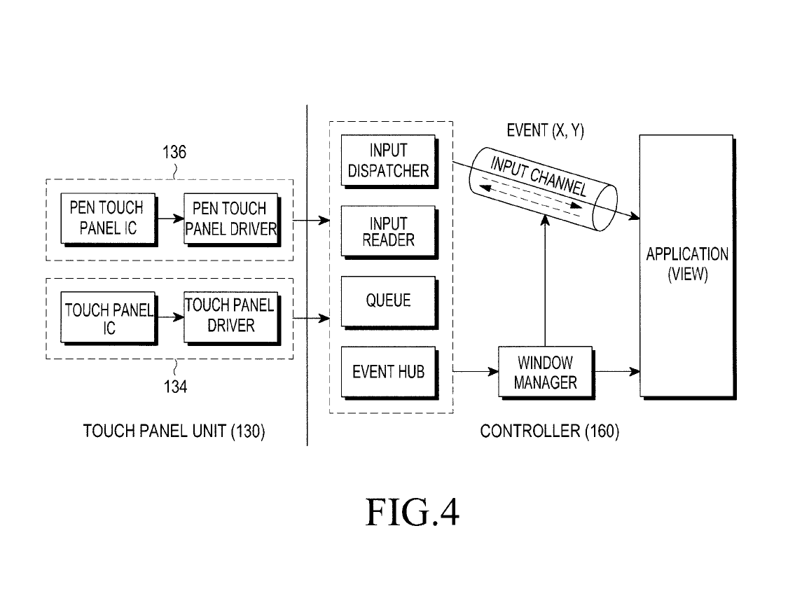

FIG. 4 is a block diagram illustrating an operation for sensing a touch input and a pen touch input through the touch panel 134 and the pen recognition panel 136 according to an exemplary embodiment of the present invention.

Referring to FIG. 4, the touch panel 134 includes a touch panel Integrated Circuit (IC) and a touch panel driver. The touch panel 134 provides information about a touched position and a touch state according to a variation in capacitance, resistance, or voltage caused by a touch of an object such as a user's finger, that is, touch input information to the controller 160.

The pen recognition panel 136 includes a pen touch panel IC and a pen touch panel driver. The pen recognition panel 136 may receive pen state information according to proximity and manipulation of the touch pen 20 and provide the pen state information to the controller 160. In addition, the pen recognition panel 143 may receive pen input recognition information according to an input gesture made with the touch pen 20 and provide the pen input recognition information to the controller 160.

The controller 160 includes an event hub, a queue, an input reader, and an input dispatcher. The controller 160 receives information from the touch panel 134 and the pen recognition panel 136 through the input reader, and generates a pen input event according to the pen state information and pen input recognition information or a touch input event according to the touch input information through the input dispatcher. The controller 160 outputs the touch input event and the pen input event through the queue and the event hub and controls input of the pen input event and the touch event through an input channel corresponding to a related application view from among a plurality of application views under management of the window manager.

The display panel 132 outputs various screens in relation to operations of the user terminal 100. For example, the display panel 132 may provide various screens according to activation of related functions, including an initial waiting screen or menu screen for supporting functions of the user terminal 100, and a file search screen, a file reproduction screen, a broadcasting reception screen, a file edit screen, a Web page accessing screen, a memo screen, an e-book reading screen, a chatting screen, and an e-mail or message writing and reception screen which are displayed according to selected functions. Each of the screens provided by the display panel 132 may have information about a specific function type, and the function type information may be provided to the controller 160. If each function of the display panel 132 is activated, the pen recognition panel 136 may be activated according to a preset setting. Pen input recognition information received from the pen recognition panel 136 may be output to the display panel 132 in its associated form. For example, if the pen recognition information is a gesture corresponding to a specific pattern, an image of the pattern may be output to the display panel 132. Thus the user may confirm a pen input that he or she has applied by viewing the image.

The starting and ending times of a pen input may be determined based on a change in pen state information about the touch pen 20 in the present invention. A gesture input may start in at least one of the contact state and hovering state of the touch pen 20 and may end when one of the contact state and hovering state is released. Accordingly, the user may apply a pen input contacting the touch pen 20 on the display panel 132 or spacing the touch pen 20 from the display panel 132 by a predetermined gap. For example, when the touch pen 20 moves in a contact-state range, the user terminal 100 may recognize the pen input such as handwriting, drawing, a touch, a touch and drag, and the like according to the movement of the touch pen 20 in the contact state. On the other hand, if the touch pen 20 is positioned in a hovering-state range, the user terminal 100 may recognize a pen input in the hovering state.

Referring back to FIG. 2, the memory 150 stores various programs and data required to operate the user terminal 100 according to the present invention. For example, the memory 150 may store an Operating System (OS) required to operate the user terminal 100 and function programs for supporting the afore-described screens displayed on the touch panel 132. The memory 150 may store a pen function program 151 to support pen functions and a pen function table 153 to support the pen function program 151 according to the present invention.

The pen function program 151 may include various routines to support the pen functions according to exemplary embodiments of the present invention. For example, the pen function program 151 may include a routine for determining an activation condition for the pen recognition panel 136, a routine for collecting pen state information about the touch pen 20 when the pen recognition panel 136 is activated, and a routine for collecting pen input recognition information by recognizing a pen input according to a gesture made by the touch pen 20. The pen function program 151 may further include a routine for generating a specific pen function command based on the collected pen state information and pen input recognition information and a routine for executing a function corresponding to the specific pen function command. In addition, the pen function program 151 may include a routine for collecting information about the type of a current active function; a routine for generating a pen function command mapped to the collected function type information, pen state information, and pen input recognition information; and a routine for executing a function corresponding to the pen function command.

The routine for generating a pen function command is designed to generate a command, referring to the pen function table 153 stored in the memory 150. The pen function table 153 may include pen function commands mapped to specific terminal functions corresponding to input gestures of the touch pen 20 by a designer or program developer. The pen function table 153 maps input gesture recognition information to pen function commands according to pen state information and function type information so that a different function may be performed according to pen state information and a function type despite the same pen input recognition information. The pen function table 153 may map pen function commands corresponding to specific terminal functions to pen state information and pen input recognition information. This pen function table 153 including only pen state information and pen input recognition information may support execution of a specific function only based on the pen state information and pen input recognition information irrespective of the type of a current active function. As described above, the pen function table 153 may include at least one of a first pen function table including pen function commands mapped to pen state information, function type information, and pen input recognition information; and a second pen function table including pen function commands mapped to pen state information and pen input recognition information. The pen function table 153 including pen function commands may be applied selectively or automatically according to a user setting or the type of an executed application program. For example, the user may preset the first or second pen function table. Then the user terminal 100 may perform a pen input recognition process on an input gesture based on the specific pen function table according to the user setting.

The user terminal 100 may apply the first pen function table when a first application is activated and the pen second function table when a second application is activated according to a design or a user setting. As described above, the pen function table 153 may be applied in various manners according to the type of an activated function. Exemplary applications of the pen function table 153 are described below.

In the case where the user terminal 100 supports a communication function, the user terminal 100 may include the communication module 170. When the user terminal 100 supports a mobile communication function, the communication module 110 may include a mobile communication module. The communication module 110 may perform communication functions such as chatting, message transmission and reception, call, and the like. If pen input recognition information is collected from the touch pen 20 while the communication module 170 is operating, the communication module 170 may support execution of a pen function command corresponding to the pen input recognition information under the control of the controller 160.

While supporting the communication functionality of the user terminal 100, the communication module 110 may receive external information for updating the pen function table 153 and provide the received external update information to the controller 160. As described above, a different pen function table 153 may be set according to the function type of an executed application program. Consequently, when a new function is added to the user terminal 100, a new setting related to operation of the touch pen 20 may be necessary. When a pen function table 153 is given for a new function or a previously installed function, the communication module 110 may support reception of information about the pen function table 153 by default or upon user request.

The input unit 180 may be configured into side keys, a separately procured touch pad, or a combination thereof. The input unit 180 may include a button for turning on or turning off the user terminal 100, a home key for returning to a home screen of the user terminal 100, etc. The input unit 180 may generate an input signal for setting a pen operation mode under user control and provide the input signal to the controller 160. The input unit 180 may generate an input signal setting one of a basic pen operation mode in which a pen's position is detected without additional pen input recognition and a function is performed according to the detected pen position and a pen operation mode based on one of the afore-described various pen function tables 153. The user terminal 100 retrieves a specific pen function table 153 according to an associated input signal and support a pen operation based on the retrieved pen function table 153.

The audio processor 140 includes at least one of a speaker (SPK) for outputting an audio signal and a microphone (MIC) for collecting an audio signal. The audio processor 140 may output a notification sound for prompting the user to set a pen operation mode or an effect sound according to a setting. When the pen recognition panel 136 collects pen input recognition information according to a specific pen input gesture, the audio processor 140 outputs a notification sound corresponding to the pen input recognition information or an effect sound associated with function execution. The audio processor 140 may output an effect sound in relation to a pen input received in real time with a pen input gesture. In addition, the audio processor 140 may control the magnitude of vibration corresponding to a gesture input by controlling a vibration module.

The audio processor 140 may differentiate the vibration magnitude according to a received gesture input. When processing different pen input recognition information, the audio processor 140 may set a different vibration magnitude. The audio processor 140 may output an effect sound of a different volume and type according to the type of pen input recognition information. For example, when pen input recognition information related to a currently executed function is collected, the audio processor 140 outputs a vibration having a predetermined magnitude or an effect sound having a predetermined volume. When pen input recognition information for invoking another function is collected, the audio processor 140 outputs a vibration having a relatively large magnitude or an effect sound having a relatively large volume.

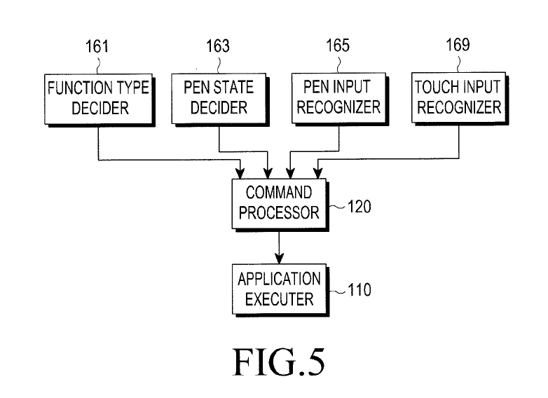

The controller 160 includes various components to support pen functions according to exemplary embodiments of the present invention and thus processes data and signals for the pen functions and controls execution of the pen functions. For this purpose, the controller 160 may have a configuration as illustrated in FIG. 5.

FIG. 5 is a detailed block diagram of a controller according to an exemplary embodiment of the present invention.

Referring to FIG. 5, the controller 160 may include the command processor 120, the application executer 110, a function type decider 161, a pen state decider 163, a pen input recognizer 165, and a touch input recognizer 169.

The function type decider 161 determines the type of a user function currently activated in the user terminal 100. The function type decider 161 collects information about the type of a function related to a current screen displayed on the display panel 132. If the user terminal 100 supports multi-tasking, a plurality of functions may be activated along with activation of a plurality of applications. In this case, the function type decider 161 may collect only information about the type of a function related to a current screen displayed on the display panel 132 and provide the function type information to the command processor 120. If a plurality of screens are displayed on the display panel 132, the function type decider 161 may collect information about the type of a function related to a screen displayed at the foremost layer.

The pen state decider 163 collects information about the position of the touch pen 20 and pressing of the button 24. As described above, the pen state decider 163 may detect a variation in an input electromagnetic induction value by scanning the pen recognition panel 136, determine whether the touch pen 20 is in the hovering state or contact state and whether the button 24 has been pressed or released, and collect pen state information according to the determination. A pen input event corresponding to the collected pen state information may be provided to the command processor 120.

The pen input recognizer 165 recognizes a pen input according to movement of the touch pen 20. The pen input recognizer 165 receives a pen input event corresponding to a pen input gesture according to movement of the touch pen 20 from the pen recognition panel 136 irrespective of whether the touch pen 20 is in the hovering state or contact state, recognizes the pen input, and provides the resulting pen input recognition information to the command processor 120. The pen input recognition information may be single-pen input recognition information obtained by recognizing one object or composite-pen input recognition information obtained by recognizing a plurality of objects. The single-pen input recognition information or composite-pen input recognition information may be determined according to a pen input gesture. For example, the pen input recognizer 165 may generate single-pen input recognition information for a pen input corresponding to continuous movement of the touch pen 20 while the touch pen 20 is kept in the hovering state or contact state. The pen input recognizer 165 may generate composite-pen input recognition information for a pen input corresponding to movement of the touch pen 20 that has been made when the touch pen 20 is switched between the hovering state and the contact state. The pen input recognizer 165 may generate composite-pen input recognition information for a pen input corresponding to movement of the touch pen 20 that has been made when the touch pen 20 is switched from the hovering state to the air state. Alternatively, the pen input recognizer 165 may generate composite-pen input recognition information for a plurality of pen inputs that the touch pen 20 has made across the boundary of a range recognizable to the pen recognition panel 136.

The touch input recognizer 169 recognizes a touch input corresponding to a touch or movement of a finger, an object, and the like. The touch input recognizer 169 receives a touch input event corresponding to the touch input, recognizes the touch input, and provides the resulting touch input recognition information to the command processor 120.

The command processor 120 generates a pen function command based on one of the function type information received from the function type decider 161, the pen state information received from the pen state decider 163, and the pen input recognition information received from the pen input recognizer 165, and generates a touch function command based on the touch input recognition information received from the touch input recognizer 169, according to an operation mode. During this operation, the command processor 120 may refer to the pen function table 153 listing a number of pen function commands. The command processor 120 may refer to a first pen function table based on the function type information, pen state information, and pen input recognition information; a second pen function table based on the pen state information and the pen input recognition information; or a third pen function table based on the pen input recognition information, according to a setting or the type of a current active function. The command processor 120 provides the generated pen function command to the application executer 110.

The application executer 110 controls execution of a function corresponding to one of commands including the pen function command and the touch function command received from the command processor 120. The application executer 110 may execute a specific function, invoke a new function, or end a specific function in relation to a current active application.

Operations of the command processor 120 and the application executer 110 are described below, beginning with the command processor 120.

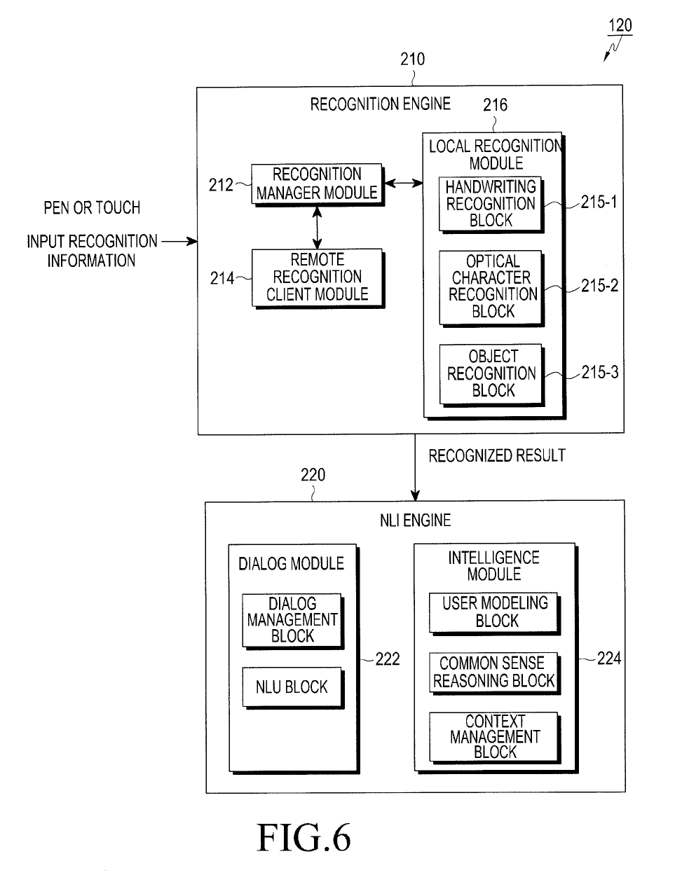

FIG. 6 is a block diagram of a command processor for supporting handwriting-based NLI in a user terminal according to an exemplary embodiment of the present invention.

Referring to FIG. 6, the command processor 120 supporting handwriting-based NLI includes a recognition engine 210 and an NLI engine 220.

The recognition engine 210 includes a recognition manager module 212, a remote recognition client module 214, and a local recognition module 216. The local recognition module 216 includes a handwriting recognition block 215-1, an optical character recognition block 215-2, and an object recognition block 215-3.

The NLI engine 220 includes a dialog module 222 and an intelligence module 224. The dialog mobile 222 includes a dialog management block for controlling a dialog flow and a Natural Language Understanding (NLU) block for recognizing a user's intention. The intelligence module 224 includes a user modeling block for reflecting user preferences, a common sense reasoning block, and a context management block for reflecting a user situation.

The recognition engine 210 may receive information from a drawing engine corresponding to input means such as an electronic pen and an intelligent input platform such as a camera. The intelligent input platform (not shown) may be an optical character recognizer such as an Optical Character Recognition (OCR) device. The intelligent input platform may read information taking the form of printed text or handwritten text, numbers, or symbols, and provide the read information to the recognition engine 210. The drawing engine is a component for receiving an input from an input means such as a finger, object, pen, etc. The drawing engine may sense input information received from the input means and provide the sensed input information to the recognition engine 210. The recognition engine 210 may recognize information received from the intelligent input platform and the touch panel unit 130.

The case where the touch panel unit 130 receives inputs from input means and provides touch input recognition information and pen input recognition information to the recognition engine 210 according to an exemplary embodiment of the present invention is described below by way of example.

According to an exemplary embodiment of the present invention, the recognition engine 210 recognizes a user-selected whole or part of a currently displayed note or a user-selected command from text, a line, a symbol, a pattern, a figure, or a combination thereof received as information. The user-selected command is a predefined input. The user-selected command may correspond to at least one of a preset symbol, pattern, text, or combination of them or at least one gesture preset by a gesture recognition function.

The recognition engine 210 outputs a recognized result obtained in the above operation. For this purpose, the recognition engine 210 includes the recognition manager module 212 for providing overall control to output a recognized result, the remote recognition client module 214, and the local recognition module 216 for recognizing input information. The local recognition module 216 includes at least the handwriting recognition block 215-1 for recognizing handwritten input information, the optical character recognition block 215-2 for recognizing information from an input optical signal, and the object recognition module 215-2 for recognizing information from an input gesture.

The handwriting recognition block 215-1 recognizes handwritten input information. For example, the handwriting recognition block 215-1 recognizes a note that the user has written down on a memory screen with the touch pen 20. The handwriting recognition block 215-1 receives the coordinates of points touched on the memo screen from the touch panel unit 130, stores the coordinates of the touched points as strokes, and generates a stroke array using the strokes. The handwriting recognition block 215-1 recognizes the handwritten content using a pre-stored handwriting library and a stroke array list including the generated stroke arrays. The handwriting recognition block 215-1 outputs the resulting recognized results corresponding to note content and a command in the recognized content.

The optical character recognition block 215-2 receives an optical signal sensed by the optical sensing module and outputs an optical character recognized result. The object recognition block 215-3 receives a gesture sensing signal sensed by the motion sensing module, recognizes a gesture, and outputs a gesture recognized result. The recognized results output from the handwriting recognition block 215-1, the optical character recognition block 215-2, and the object recognition block 215-3 are provided to the NLI engine 220 or the application executer 110.

The NLI engine 220 determines the intention of the user by processing, for example, the recognized results received from the recognition engine 210. The NLI engine 220 determines user-intended input information from the recognized results received from the recognition engine 210. The NLI engine 220 collects sufficient information by exchanging questions and answers with the user based on handwriting-based NLI and determines the intention of the user based on the collected information.

For this operation, the dialog module 222 of the NLI engine 220 creates a question to make a dialog with the user and provides the question to the user, thereby controlling a dialog flow to receive an answer from the user. The dialog module 222 manages information acquired from questions and answers via the dialog management block. The dialog module 222 also understands the intention of the user by performing a natural language process on an initially received command, taking into account the managed information via the NLU block.

The intelligence module 224 of the NLI engine 220 generates information to be referred to for understanding the intention of the user through the natural language process and provides the reference information to the dialog module 222. For example, the intelligence module 224 models information reflecting a user preference by analyzing a user's habit in making a note via the user modeling block, induces information for reflecting common sense via the common sense reasoning block, or manages information representing a current user situation via the context management block.

Accordingly, the dialog module 222 may control a dialog flow in a question and answer procedure with the user with the help of information received from the intelligence module 224.

The application executer 110 receives a recognized result corresponding to a command from the recognition engine 210, searches for the command in a pre-stored synonym table, and reads an ID corresponding to a synonym corresponding to the command, in the presence of the synonym matching to the command in the synonym table. The application executer 110 then executes a method corresponding to the ID listed in a pre-stored method table. Accordingly, the method executes an application corresponding to the command and the note content are provided to the application. The application executer 110 executes an associated function of the application using the note content.

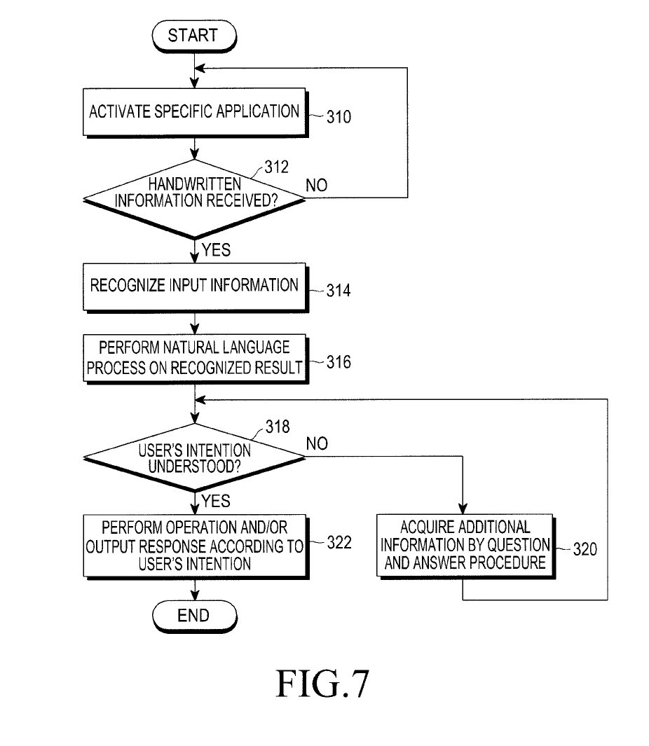

FIG. 7 is a flowchart illustrating a control operation for supporting a UI using handwriting-based NLI in a user terminal according to an exemplary embodiment of the present invention.

Referring to FIG. 7, the user terminal activates a specific application and provides a function of the activated application in step 310. The specific application is an application of which the activation has been requested by the user from among applications that were installed in the user terminal upon user request.

For example, the user may activate the specific application by the memo function of the user terminal. The user terminal invokes a memo layer upon user request. Upon receipt of ID information of the specific application and information corresponding to an execution command, the user terminal searches for the specific application and activates the detected application. This method is useful for fast execution of an intended application from among a large number of applications installed in the user terminal.

The ID information of the specific application may be the name of the application, for example. The information corresponding to the execution command may be a figure, symbol, pattern, text, etc. preset to command activation of the application.

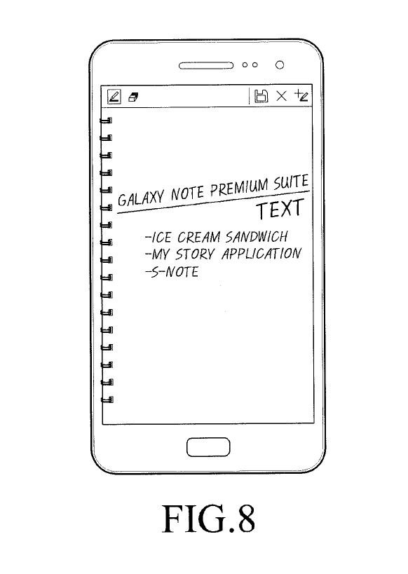

FIG. 8 illustrates an example of requesting an operation based on a specific application or function by the memo function according to an exemplary embodiment of the present invention.

Referring to FIG. 8, a part of a note written down by the memo function is selected using a line, a closed loop, or a figure, and the selected note content is processed using another application. In FIG. 8, the note content “galaxy note premium suite” is selected using a line and a command is issued to send the selected note content using a text sending application.

After “galaxy note premium suite” is underlined on a memory screen, upon receipt of a word ‘text’ corresponding to a text command, the user terminal determines the input word corresponding to the text command received after the underlining as a text sending command and sends the note content using the text sending application. When an area is selected and an input corresponding to a command is received, the user terminal determines the input as a command and determines pen-input content included in the selected area as note content.

If no application matches the user input in the user terminal, a candidate set of similar applications may be provided to the user so that the user may select an intended application from among the candidate applications.

In another example, a function supported by the user terminal may be executed by the memo function. For this purpose, the user terminal invokes a memo layer upon user request and searches for an installed application according to user-input information.

For example, a search keyword may be input to a memo screen displayed for the memo function in order to search for a specific application among applications installed in the user terminal. Then the user terminal searches for the application matching to the input keyword. If the user writes down “car game” on the screen by the memo function, the user terminal searches for applications related to ‘car game’ among the installed applications and provides the search results on the screen.

In another example, the user may input an installation time, for example, February 2011 on the screen by the memo function. Then the user terminal searches for applications installed in February 2011. When the user writes down ‘February 2011’ on the screen by the memo function, the user terminal searches for applications installed in ‘February 2011’ among the installed applications and provides the search results on the screen.

As described above, activation of or search for a specific application based on a user's note is useful, in the case where a large number of applications are installed in the user terminal.

For more efficient search for applications, the installed applications may be indexed. The indexed applications may be classified by categories such as feature, field, function, etc.

Upon user input of a specific key or gesture, the memo layer may be invoked to allow the user to input ID information of an application to be activated or to input index information to search for a specific application.

Specific applications activated or searched for in the above-described manner include a memo application, a scheduler application, a map application, a music application, and a subway application.

Referring back to FIG. 7, upon activation of the specific application, the user terminal monitors input of handwritten information in step 312. The input information may take the form of a line, symbol, pattern, or a combination of them as well as text. The user terminal may also monitor input of information indicating an area that selects a whole or part of the note written down on the current screen.

If the note is partially or wholly selected, the user terminal continuously monitors additional input of information corresponding to a command in order to process the selected note content in step 312.

Upon sensing input of handwritten information, the user terminal performs an operation for recognizing the sensed input information in step 314. For example, text information of the selected whole or partial note content is recognized or the input information taking the form of a line, symbol, pattern, or a combination of them in addition to text is recognized. The recognition engine 210 illustrated in FIG. 6 is responsible for recognizing the input information.

Once the user terminal recognizes the sensed input information, the user terminal performs a natural language process on the recognized text information to understand the content of the recognized text information in step 316. The NLI engine 220 is responsible for the natural language process of the recognized text information.

If the input information is a combination of text and a symbol, the user terminal also processes the symbol along with the natural language process.

In the symbol process, the user terminal analyzes an actual memo pattern of the user and detects a main symbol that the user frequently uses by the analysis of the memo pattern. Then the user terminal analyzes the intention of using the detected main symbol and determines the meaning of the main symbol based on the analysis result.

The meaning that the user intends for each main symbol is built into a database, for later use in interpreting a later input symbol. The prepared database may be used for symbol processing.

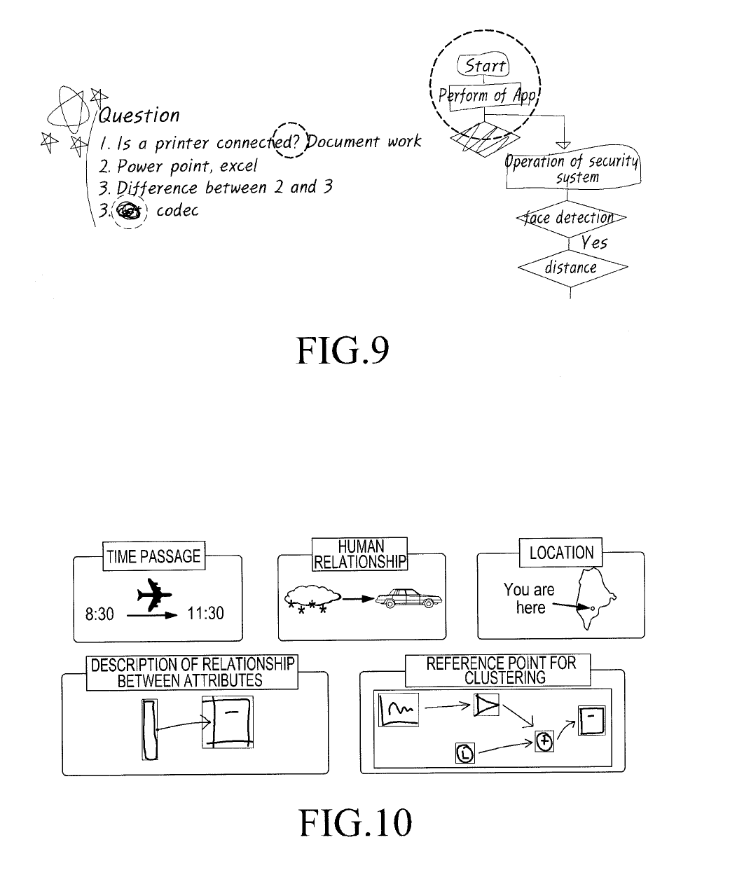

FIG. 9 illustrates an exemplary actual memo pattern of a user for use in implementing according to an exemplary embodiment of the present invention.

Referring to FIG. 9, the memo pattern demonstrates that the user frequently uses symbols →, ( ), _, +, and ?. For example, the symbol → is used for additional description or paragraph separation and symbol ( ) indicates that the content within ( ) is a definition of a term or a description.

The same symbol may be interpreted as having different meanings. For example, the symbol → may signify ‘time passage’, ‘cause and result relationship’, ‘position’, ‘description of a relationship between attributes’, ‘a reference point for clustering’, ‘change’, and the like.

FIG. 10 illustrates an example in which one symbol may be interpreted as various meanings according to an exemplary embodiment of the present invention.

Referring to FIG. 10, the symbol → may be used in the meanings of time passage, cause and result relationship, position, etc.

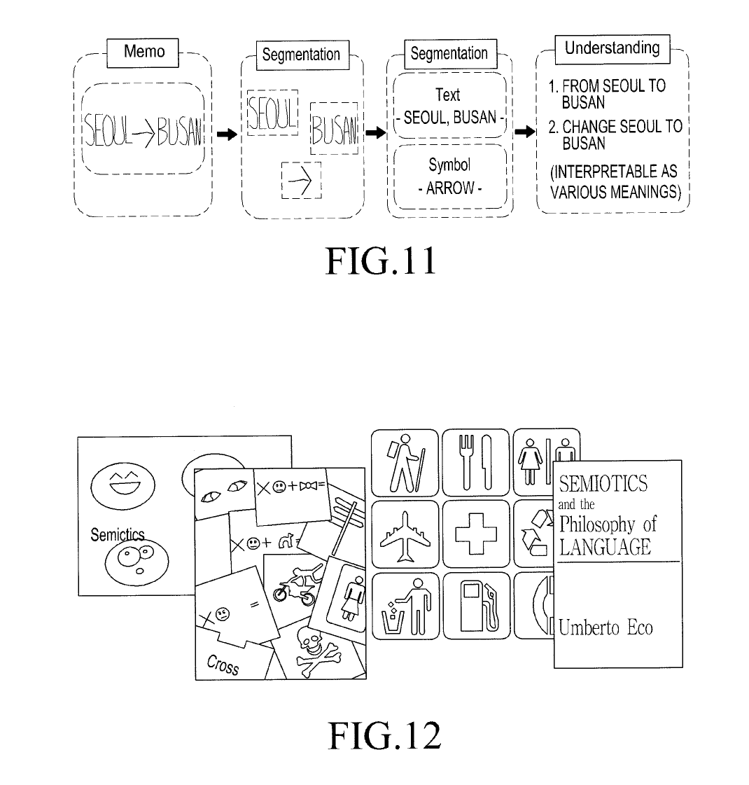

FIG. 11 illustrates an example in which input information including a combination of text and a symbol may be interpreted as different meanings depending on a symbol according to an exemplary embodiment of the present invention.

User-input information ‘Seoul→Busan’ may be interpreted to imply that ‘Seoul is changed to Busan’ as well as ‘from Seoul to Busan’. The symbol that allows a plurality of meanings may be interpreted by taking into account additional information or the relationship with previous or following information. However, this interpretation may lead to inaccurate assessment of the user's intention.

To address this issue, extensive research and efforts on symbol recognition/understanding are necessary. For example, the relationship between symbol recognition and understanding is under research in semiotics of the liberal arts field; this research is utilized in advertisements, literature, movies, traffic signals, and the like. Semiotics is, in its broad sense, the theory and study of functions, analysis, interpretation, meanings, and representations of signs and symbols, and various systems related to communication.

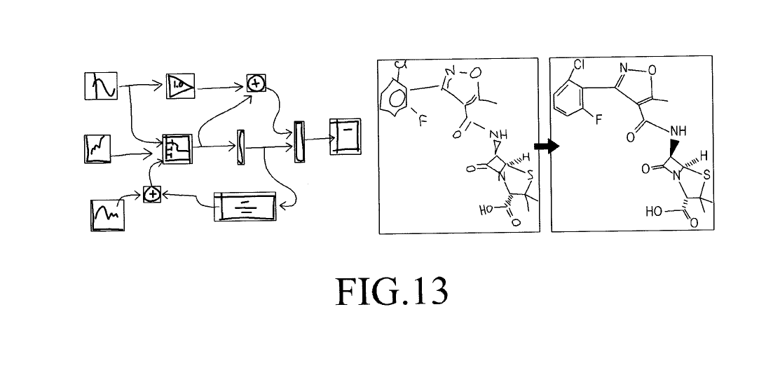

FIG. 12 illustrates exemplary uses of signs and symbols in semiotics according to an exemplary embodiment of the present invention, and FIG. 13 illustrates exemplary uses of signs and symbols in the fields of mechanical/electrical/computer engineering and chemistry according to an exemplary embodiment of the present invention.

Referring to FIGS. 12 and 13, signs and symbols are also studied from the perspective of engineering science. For example, research is conducted on symbol recognition of a flowchart and a blueprint in the field of mechanical/electrical/computer engineering. The research is used in sketch (hand-drawn diagram) recognition. Further, recognition of complicated chemical structure formulas is studied in chemistry and this study is used in hand-drawn chemical diagram recognition.

Referring back to FIG. 7, the user terminal understands the content of the user-input information by the natural language process of the recognized result and then assesses the intention of the user regarding the input information based on the recognized content in step 318.

Once the user terminal determines the user's intention regarding the input information, the user terminal performs an operation corresponding to the user's intention or outputs a response corresponding to the user's intention in step 322. After performing the operation corresponding to the user's intention, the user terminal may output the result of the operation to the user.

If the user terminal fails to determine the user's intention regarding the input information, the user terminal acquires additional information by a question and answer procedure with the user to determine the user's intention in step 320. For this purpose, the user terminal creates a question to ask the user and provides the question to the user. When the user inputs additional information by answering the question, the user terminal re-assesses the user's intention, taking into account the new input information in addition to the content understood previously by the natural language process.

While not shown, the user terminal may additionally perform steps 314 and 316 to understand the new input information.

Until assessing the user's intention accurately, the user terminal may acquire most of information required to determine the user's intention by exchanging questions and answers with the user via a dialog with the user in step 320.

Once the user terminal determines the user's intention in the afore-described question and answer procedure, the user terminal performs an operation corresponding to the user's intention or outputs a response result corresponding to the user's intention to the user in step 322.

The configuration of the UI apparatus in the user terminal and the UI method using handwriting-based NLI in the UI apparatus may be considered in various scenarios.

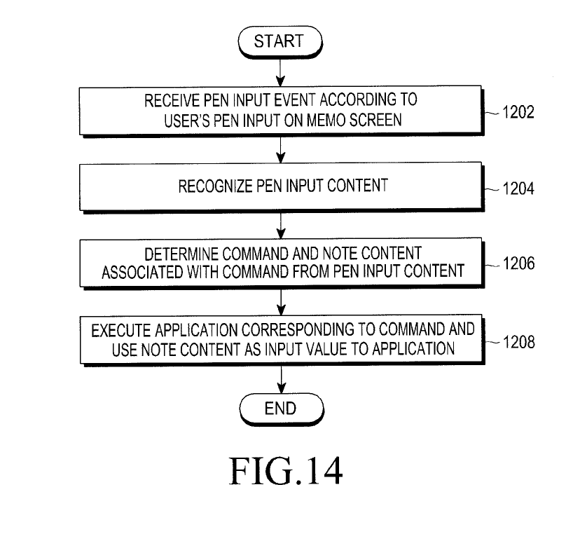

FIGS. 14, 15, 16A and 16B, 17A and 17B, 18A and 18B, 19A, 19B, and 19C, 20, 21A, and 21B illustrate operation scenarios based on applications supporting a memo function according to an exemplary embodiments of the present invention.

Referring to FIGS. 14, 15, 16A and 16B, 17A and 17B, 18A and 18B, 19A, 19B, and 19C, 20, 21A, and 21B, various examples of processing a note written down in an application supporting a memo function by launching another application according to exemplary embodiments of the present invention are illustrated.

FIG. 14 is a flowchart illustrating an operation of processing a note written down in an application supporting a memo function by launching another application according to an exemplary embodiment of the present invention.

Referring to FIG. 14, upon execution of a memo application, the user terminal 100 displays a memo screen through the touch panel unit 130 and receives a note that the user has written down on the memo screen in step 1202. The user terminal 100 may acquire a pen input event through the pen recognition panel 136 in correspondence with a pen input from the user and may acquire a touch input event through the touch panel 134 in correspondence with a touch input from the user's finger or an object. In accordance with an exemplary embodiment of the present invention, as the user writes down a note with the touch pen 20, the user terminal 100 receives a pen input event through the pen recognition panel 136, by way of example. The user may input a command as well as write down a note on the memo screen by means of the touch pen 20.

In step 1204, the user terminal recognizes the content of the pen input according to the pen input event. The user terminal may recognize the content of the pen input using the handwriting recognition block 215-1 of the recognition engine 210. For example, the handwriting recognition block 215-1 receives the coordinates of points touched on the memo screen from the touch panel unit 130, stores the received coordinates of the touched points as strokes, and generates a stroke array with the strokes. The handwriting recognition block 215-1 recognizes the content of the pen input using a pre-stored handwriting library and a stroke array list including the generated stroke array.

In step 1206, the user terminal determines a command and note content for which the command is to be executed, from the recognized pen input content. The user terminal may determine a selected whole or partial area of the pen input content as the note content for which the command is to be executed. In the presence of a predetermined input in the selected whole or partial area, the user terminal may determine the predetermined input as a command. The predetermined input corresponds to at least one of a preset symbol, pattern, text, or combination of them or at least one gesture preset by a gesture recognition function.

For example, when the user inputs a word ‘text’ corresponding to a text command after underlining ‘galaxy note premium suite’ on the memo screen as illustrated in FIG. 8, the user terminal determines the word corresponding to the text command as a text sending command and determines the pen-input content of the underlined area as note content to be sent.

The user terminal executes an application corresponding to the command and executes a function of the application by receiving the note content as an input data to the executed application in step 1208.

The user terminal may execute a function of an application corresponding to the command by activating the application through the application executer 110. The application executer 110 receives a recognized result corresponding to the command from the recognition engine 210, checks whether the command is included in a pre-stored synonym table, and in the presence of a synonym corresponding to the command, reads an ID corresponding to the synonym. Then the application executer 110 executes a method corresponding to the ID, referring to a preset method table. Accordingly, the method executes the application according to the command, transfers the note content to the application, and executes the function of the application using the note content as input data.

After executing the function of the application, the user terminal may store the handwritten content, (i.e., the pen input content) and information about the application whose function has been executed, as a note.

The stored note may be retrieved upon user request. For example, upon receipt of a request for retrieving the stored note from the user, the user terminal retrieves the stored note, displays the handwritten content of the stored note, (i.e., the pen input content) and information about an already executed application on the memo screen. When the user edits the handwritten content, the user terminal may receive a pen input event editing the handwritten content of the retrieved note from the user. If an application has already been executed for the stored note, the application may be re-executed upon receipt of a request for re-execution of the application.

Applications that are executed by handwriting recognition may include a sending application for sending mail, text, messages, etc., a search application for searching the Internet, a map, etc., a save application for storing information, and a translation application for translating one language into another.

An exemplary embodiment of the present invention applied to a mail sending application is described below.

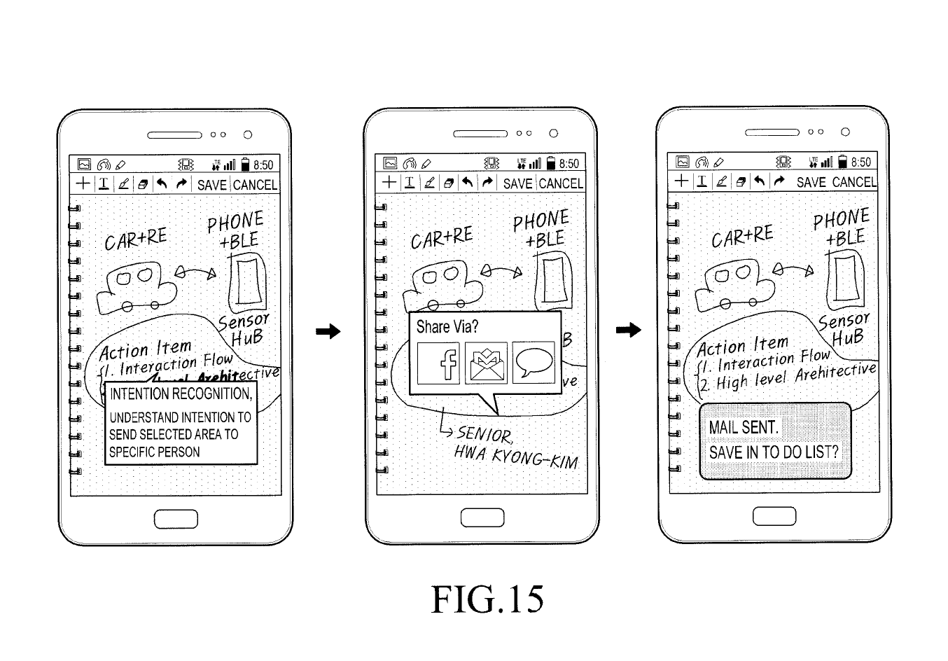

FIG. 15 illustrates a scenario of sending a part of a note as a mail by the memo function at the user terminal according to an exemplary embodiment of the present invention.

Referring to FIG. 15, the user writes down a note on the screen of the user terminal by the memo function and selects a part of the note by means of a line, symbol, closed loop, etc. For example, a partial area of the whole note may be selected by drawing a closed loop, thereby selecting the content of the note within the closed loop.

Then the user inputs a command requesting processing the selected content using a preset or intuitively recognizable symbol and text. For example, the user draws an arrow indicating the selected area and writes text indicating a person (Senior, Hwa Kyong-KIM).

Upon receipt of the information, the user terminal interprets the user's intention as meaning that the note content of the selected area are to be sent to ‘Senior, Hwa Kyong-KIM’. For example, the user terminal determines a command corresponding to the arrow indicating the selected area and the text indicating the person (Senior, Hwa Kyong-KIM). After determining the user's intention, for example, the command, the user terminal extracts recommended applications capable of sending the selected note content from among installed applications. Then the user terminal displays the extracted recommended applications so that the user may request selection or activation of a recommended application.

When the user selects one of the recommended applications, the user terminal launches the selected application and sends the selected note content to ‘Senior, Hwa Kyong-KIM’ by the application.

If information about the recipient is not pre-registered, the user terminal may ask the user for a mail address of ‘Senior, Hwa Kyong-KIM’. In this case, the user terminal may send the selected note content in response to reception of the mail address from the user.

After processing the user's intention, (e.g., the command) the user terminal displays the processed result on the screen so that the user may confirm appropriate processing conforming to the user's intention. For example, the user terminal asks the user whether to store details of the sent mail in a list, while displaying a message indicating completion of the mail sending. When the user requests to store the details of the sent mail in the list, the user terminal registers the details of the sent mail in the list.

The above scenario can help to increase throughput by allowing the user terminal to send content of a note written down during a conference to the other party without the need for shifting from one application to another and to send the message or to store details of the sent mail through interaction with the user.

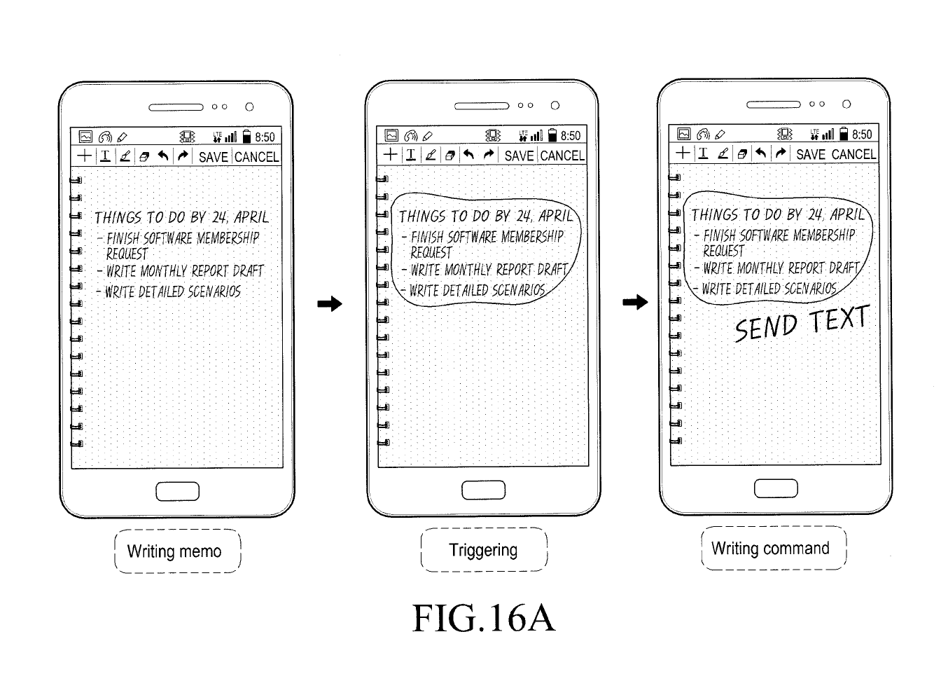

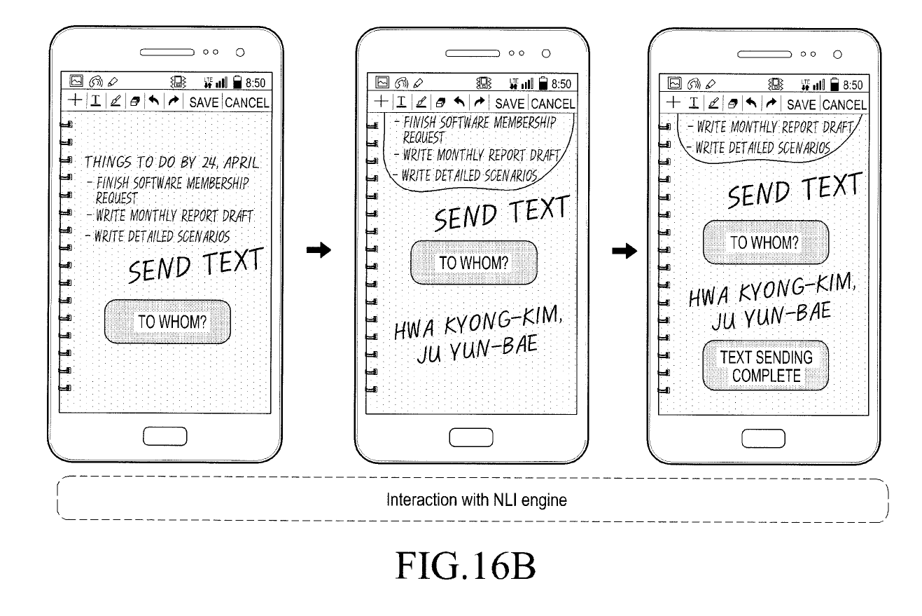

FIGS. 16A and 16B illustrate a scenario in which a user terminal sends a whole note by a memo function according to an exemplary embodiment of the present invention.

Referring to FIGS. 16A and 16B, the user writes down a note on a screen by the memo function (Writing memo). Then the user selects the whole note using a line, symbol, closed loop, and the like. (Triggering). For example, when the user draws a closed loop around the full note, the user terminal may recognize that the whole content of the note within the closed loop are selected.

The user requests text-sending of the selected content by writing down a preset or intuitively recognizable text, for example, ‘send text’ (Writing command).

The NLI engine that configures a UI based on user-input information recognizes that the user intends to send the content of the selected area in text. Then the NLI engine further acquires necessary information by exchanging a question and an answer with the user, determining that information is insufficient for text sending. For example, referring to FIG. 16B, the NLI engine asks the user to whom to send the text, for example, by displaying a dialog ‘To whom?’.

The user inputs information about a recipient to receive the text by the memo function as an answer to the question. The name or phone number of the recipient may be directly input as the information about the recipient. In FIG. 16B, ‘Hwa Kyong-KIM’ and ‘Ju Yun-BAE’ are input as recipient information.

The NLI engine detects phone numbers mapped to the input names ‘Hwa Kyong-KIM’ and ‘Ju Yun-BAE’ in a directory and sends text having the selected note content as a text body to the phone numbers. If the selected note content is an image, the user terminal may additionally convert the image to text so that the other party may recognize the image.

Upon completion of the text sending, the NLI engine displays a notification indicating the processed result, for example, a message ‘text has been sent’. Therefore, the user can confirm that the process has been appropriately completed as intended.

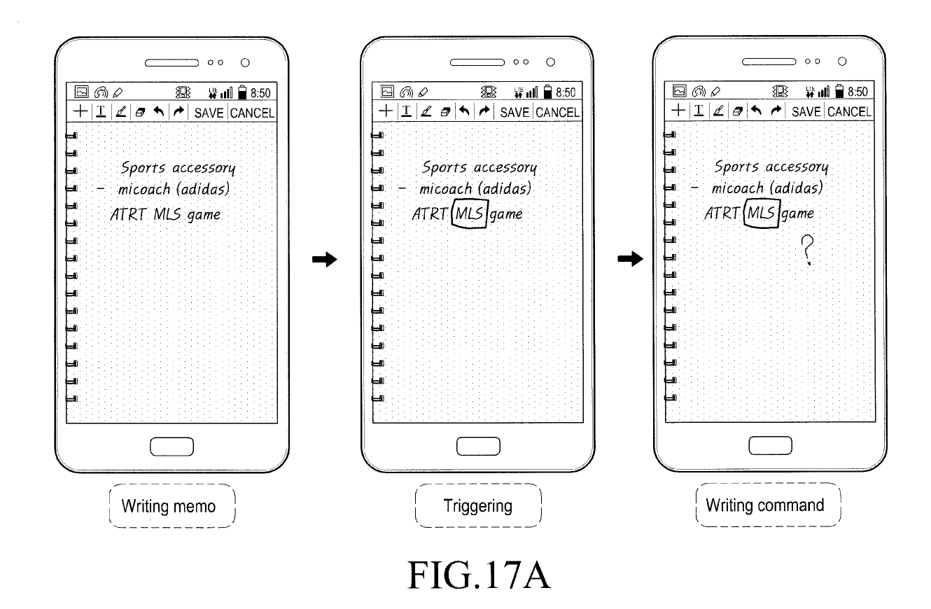

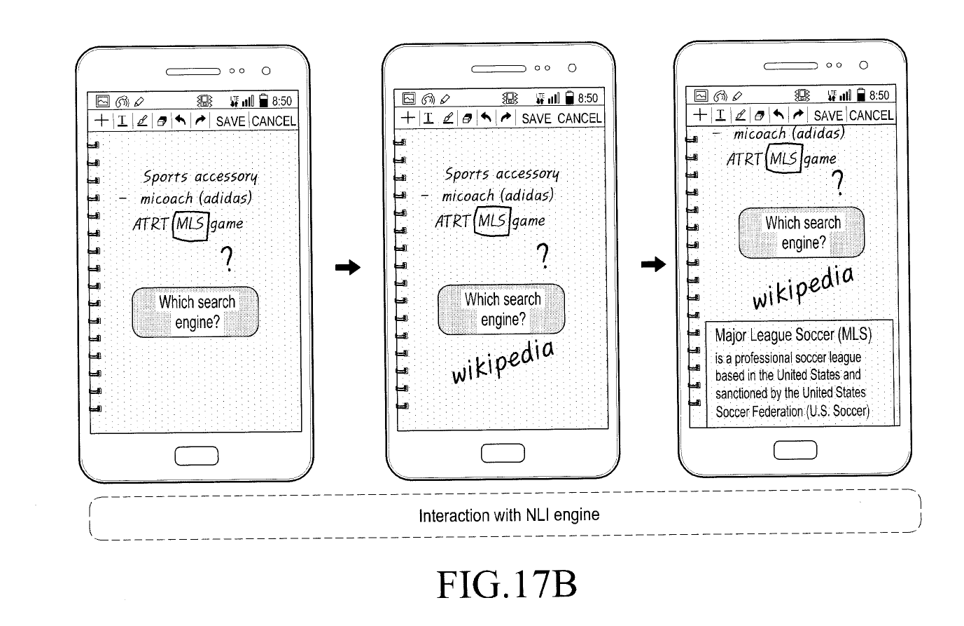

FIGS. 17A and 17B illustrate a scenario of finding the meaning of a part of a note by the memo function at the user terminal according to an exemplary embodiment of the present invention.

Referring to FIGS. 17A and 17B, the user writes down a note on a screen by the memo function (Writing memo). Then the user selects a part of the note using a line, symbol, closed loop, etc. (Triggering). For example, the user may select one word written in a partial area of the note by drawing a closed loop around the word.

The user requests the meaning of the selected text by writing down a preset or intuitively recognizable symbol, for example, ‘?’ (Writing command).

The NLI engine that configures a UI based on user-input information asks the user which engine to use in order to find the meaning of the selected word. For this purpose, the NLI engine uses a question and answer procedure with the user. For example, the NLI engine prompts the user to input information selecting a search engine by displaying ‘Which search engine?’ on the screen.

The user inputs ‘wikipedia’ as an answer by the memo function. Thus, the NLI engine recognizes that the user intends to use ‘wikipedia’ as a search engine using the user input as a keyword. The NLI engine finds the meaning of the selected ‘MLS’ using ‘wikipedia’ and displays the search results. Accordingly, the user is aware of the meaning of the ‘MLS’ from the information displayed on the screen.

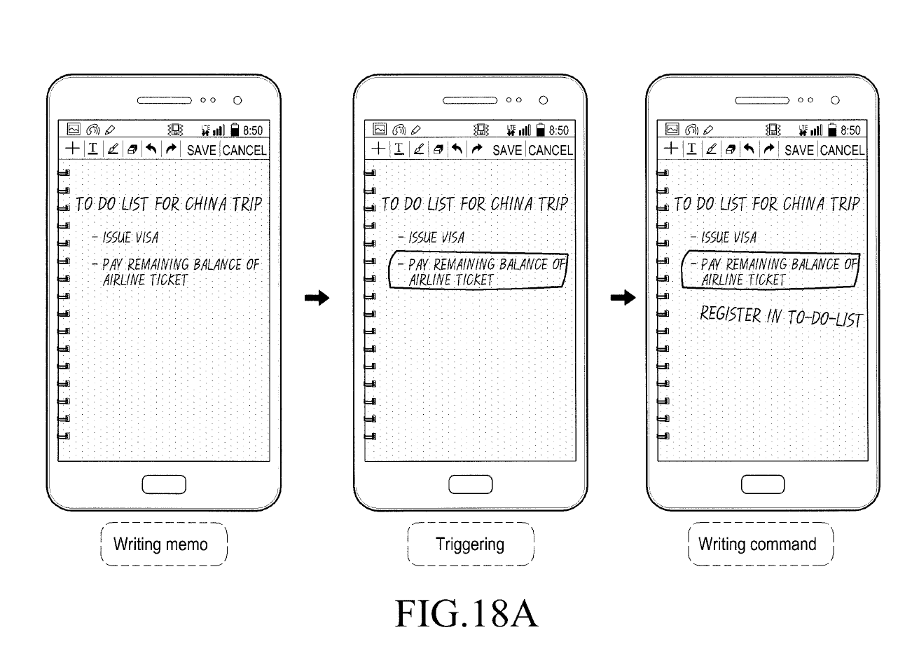

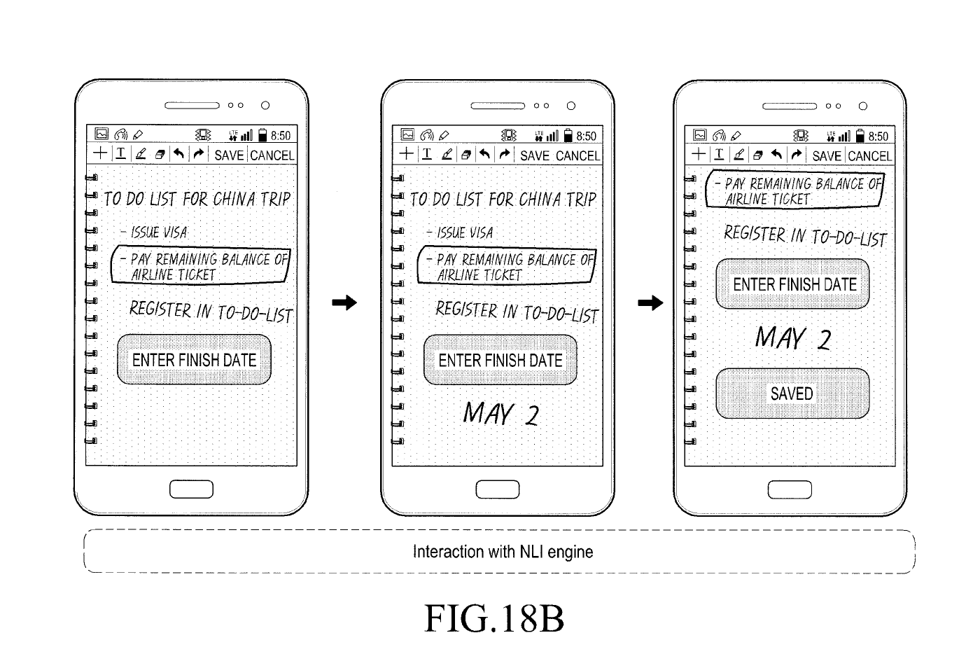

FIGS. 18A and 18B illustrate a scenario of registering a part of a note written down by a memo function as information for another application at a user terminal according to an exemplary embodiment of the present invention.

Referring to FIGS. 18A and 18B, the user writes down a to-do-list of things to prepare for a China trip on a screen of the user terminal by the memo function (Writing memo). Then the user selects a part of the note using a line, symbol, closed loop, and the like. (Triggering). For example, the user may select ‘pay remaining balance of airline ticket’ in a part of the note by drawing a closed loop around the text.

The user requests registration of the selected note content in a to-do-list by writing down preset or intuitively recognizable text, for example, ‘register in to-do-list’ (Writing command).

The NLI engine that configures a UI based on user-input information recognizes that the user intends to request scheduling of a task corresponding to the selected content of the note. Then the NLI engine further acquires necessary information by a question and answer procedure with the user, determining that information is insufficient for scheduling. For example, the NLI engine prompts the user to input information by asking a schedule, for example, ‘Enter finish date’.

The user inputs ‘May 2’ as a date on which the task should be performed by the memo function as an answer. Accordingly, the NLI engine stores the selected content as a thing to do by May 2, for scheduling.

After processing the user's request, the NLI engine displays the processed result, for example, a message ‘saved’. Therefore, the user is aware that an appropriate process has been performed as intended.

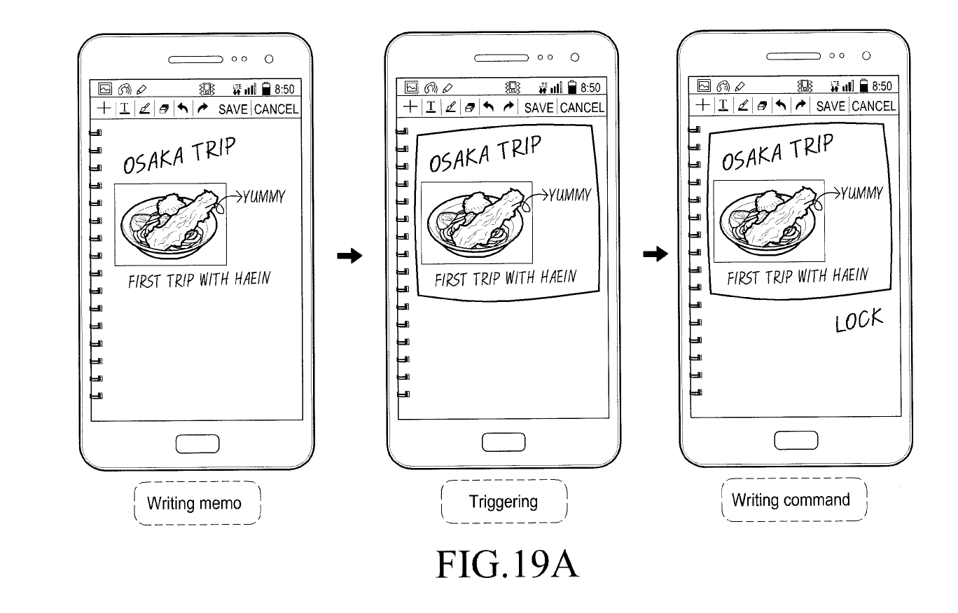

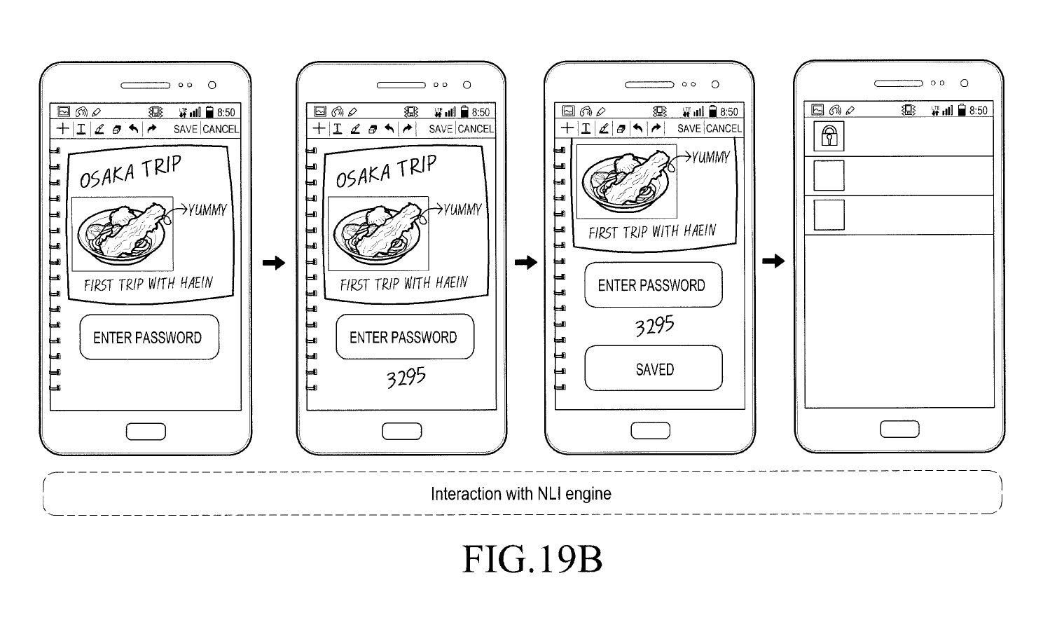

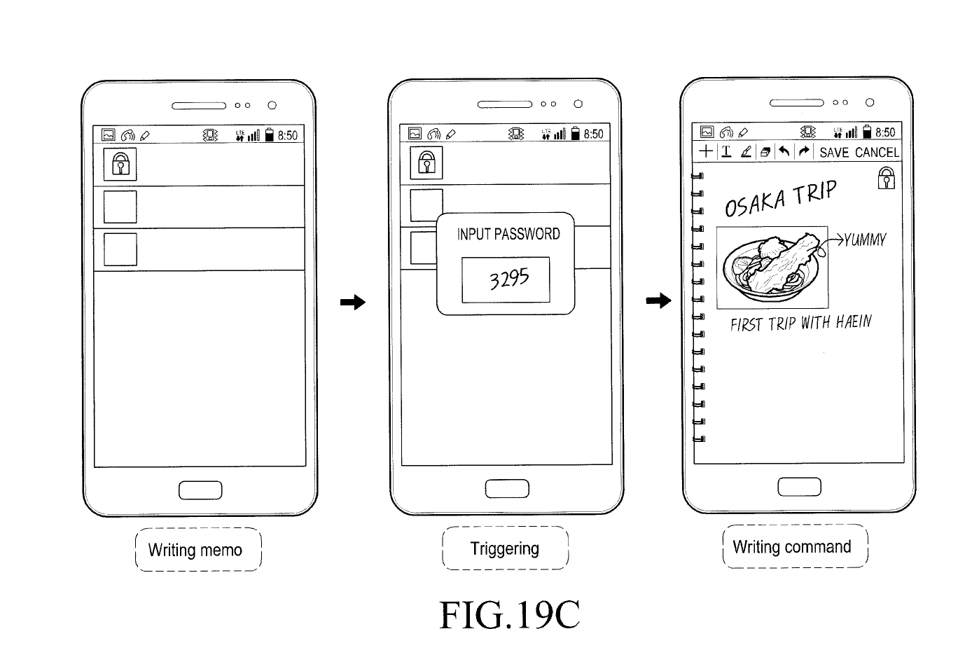

FIGS. 19A and 19B illustrate a scenario of storing a note written down by a memo function using a lock function at a user terminal according to an exemplary embodiment of the present invention. FIG. 19C illustrates a scenario of reading the note stored by the lock function according to an exemplary embodiment of the present invention.

Referring to FIGS. 19A and 19B, the user writes down the user's experiences during an Osaka trip using a photo and a note on a screen of the user terminal by the memo function (Writing memo). Then the user selects the whole note or a part of the note using a line, symbol, closed loop, and the like. (Triggering). For example, the user may select the whole note by drawing a closed loop around the note.

The user requests registration of the selected note content by the lock function by writing down preset or intuitively recognizable text, for example, ‘lock’ (Writing command).

Referring to FIG. 19B, the NLI engine that configures a UI based on user-input information recognizes that the user intends to store the content of the note by the lock function. Then the NLI engine further acquires necessary information by a question and answer procedure with the user, determining that information is insufficient for setting the lock function. For example, the NLI displays a question asking a password, for example, a message ‘Enter password’ on the screen to set the lock function.

The user inputs ‘3295’ as the password by the memo function as an answer in order to set the lock function. Thus, the NLI engine stores the selected note content using the password ‘3295’.

After storing the note content by the lock function, the NLI engine displays the processed result, for example, a message ‘Saved’. Accordingly, the user is aware that an appropriate process has been performed as intended.

Referring to FIG. 19C, the user selects a note from among notes stored by the lock function (Selecting memo). Upon selection of a specific note by the user, the NLI engine prompts the user to enter the password by a question and answer procedure, upon determining that the password is needed to provide the selected note (Writing password). For example, the NLI engine displays a memo window in which the user may enter the password. When the user enters the valid password, the NLI engine displays the selected note on a screen.

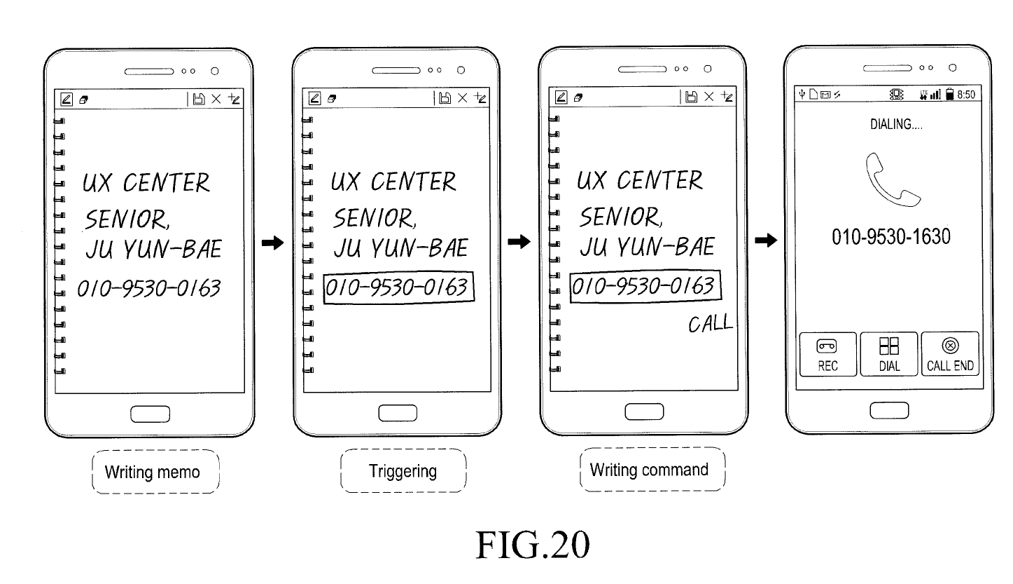

FIG. 20 illustrates a scenario of executing a specific function using a part of a note written down by the memo function at the user terminal according to an exemplary embodiment of the present invention.

Referring to FIG. 20, the user writes down a note on a screen of the user terminal by the memo function (Writing memo). Then the user selects a part of the note using a line, symbol, closed loop, and the like. (Triggering). For example, the user may select a phone number ‘010-9530-0163’ in a part of the note by drawing a closed loop around the phone number.

The user requests dialing of the phone number by writing down preset or intuitively recognizable text, for example, ‘call’ (Writing command).

The NLI engine that configures a UI based on user-input information recognizes the selected phone number by translating the phone number into a natural language and attempts to dial the phone number ‘010-9530-0163’.

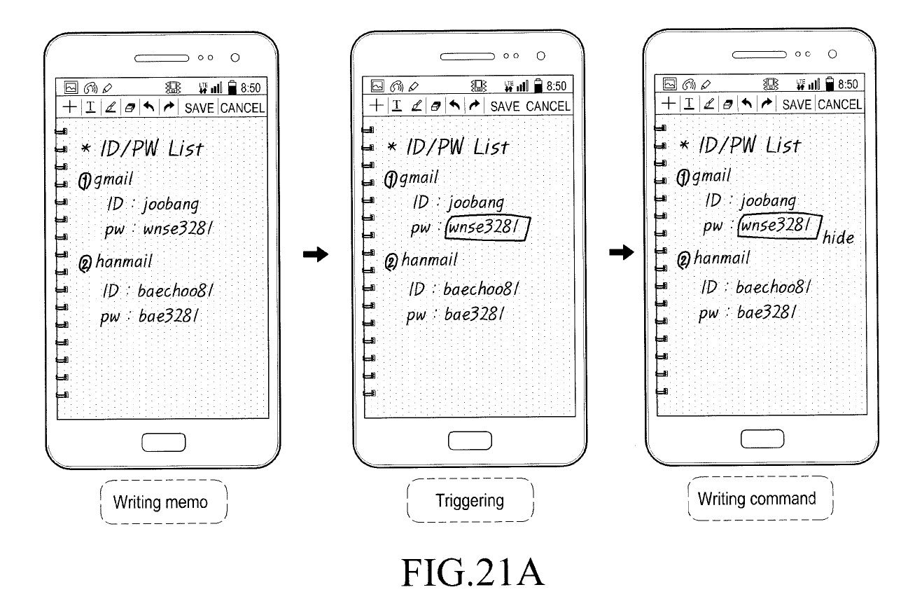

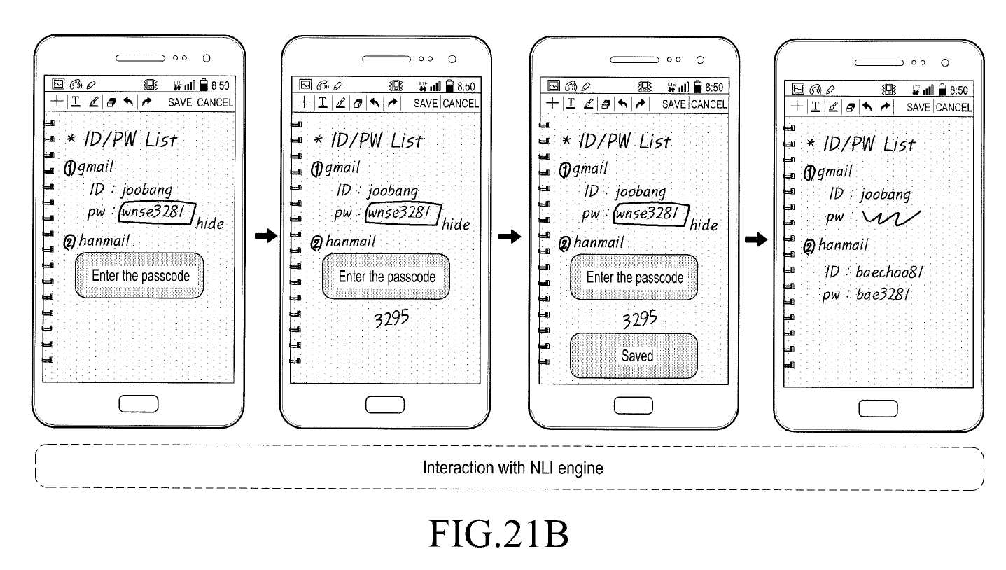

FIGS. 21A and 21B illustrate a scenario of hiding a part of a note written down by a memo function at a user terminal according to an exemplary embodiment of the present invention.

Referring to FIGS. 21A and 21B, the user writes down an ID and a password for each Web site that the user visits on a screen of the user terminal by the memo function (Writing memo). Then the user selects a part of the note using a line, symbol, closed loop, etc. (Triggering). For example, the user may select a password ‘wnse3281’ in a part of the note by drawing a closed loop around the password.

The user requests hiding of the selected content by writing down preset or intuitively recognizable text, for example, ‘hide’ (Writing command).

The NLI engine that configures a UI based on user-input information recognizes that the user intends to hide the selected note content. To use a hiding function, the NLI engine further acquires necessary information from the user by a question and answer procedure, upon determining that additional information is needed. Referring to FIG. 21B, the NLI engine outputs a question asking the password, for example, a message ‘Enter the password’ to set the hiding function.

When the user writes down ‘3295’ as the password by the memo function as an answer to set the hiding function, the NLI engine recognizes ‘3295’ by translating it into a natural language and stores ‘3295’. Then the NLI engine hides the selected note content so that the password does not appear on the screen.

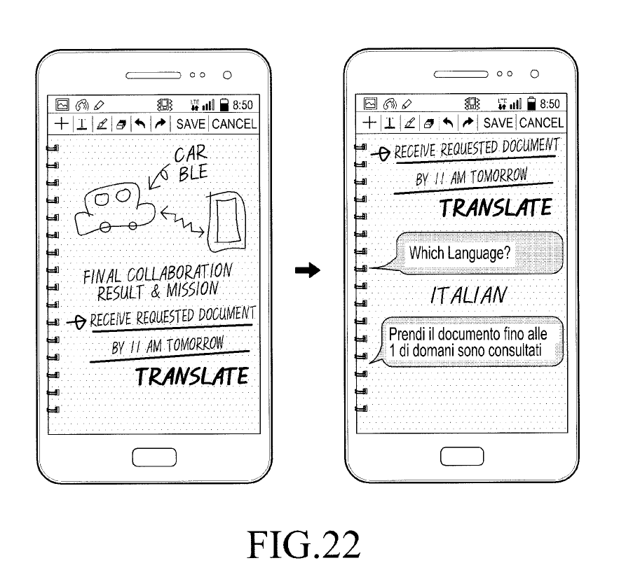

FIG. 22 illustrates a scenario of translating a part of a note written down by a memo function at a user terminal according to an exemplary embodiment of the present invention.

Referring to FIG. 22, the user writes down a note on a screen of the user terminal by the memo function (Writing memo). Then the user selects a part of the note using a line, symbol, closed loop, etc. (Triggering). For example, the user may select a sentence ‘receive requested document by 11 AM tomorrow’ in a part of the note by underlining the sentence.

The user requests translation of the selected content by writing down preset or intuitively recognizable text, for example, ‘translate’ (Writing command).

The NLI engine that configures a UI based on user-input information recognizes that the user intends to request translation of the selected note content. Then the NLI engine displays a question asking a language into which the selected note content are to be translated by a question and answer procedure. For example, the NLI engine prompts the user to enter an intended language by displaying a message ‘Which language’ on the screen.

When the user writes down ‘Italian’ as the language by the memo function as an answer, the NLI engine recognizes that ‘Italian’ is the user's intended language. Then the NLI engine translates the recognized note content (i.e., the sentence ‘receive requested document by 11 AM tomorrow’) into Italian and outputs the translation. Accordingly, the user reads the Italian translation of the requested sentence on the screen.

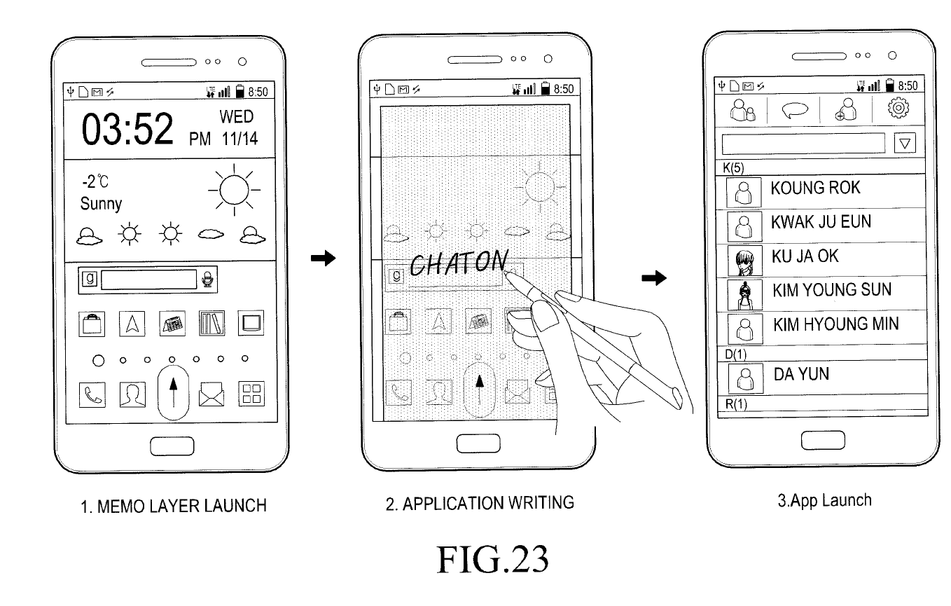

FIGS. 23 to 28 illustrate exemplary scenarios of launching an application supporting a memo function after a specific application is activated and then executing the activated application by the launched application according to an exemplary embodiment of the present invention.

FIG. 23 illustrates a scenario of executing a memo layer on a home screen of a user terminal and executing a specific application on the memo layer according to an exemplary embodiment of the present invention.

Referring to FIG. 23, the user terminal launches a memo layer on the home screen by executing a memo application on the home screen and executes an application, upon receipt of identification information about the application (e.g. the name of the application) ‘Chaton’.

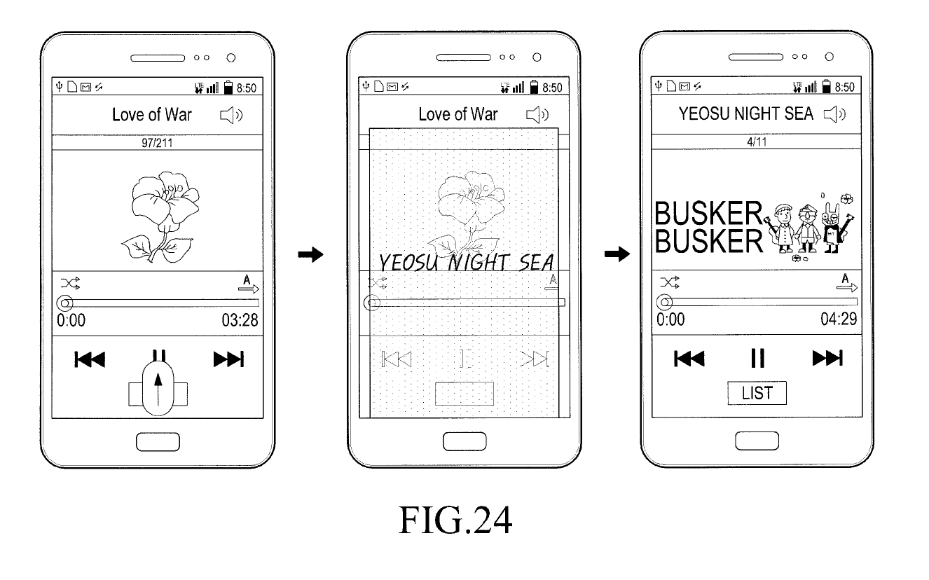

FIG. 24 illustrates a scenario of controlling a specific operation in a specific active application by the memo function at the user terminal according to an exemplary embodiment of the present invention.

Referring to FIG. 24, a memo layer is launched by executing a memo application on a screen on which a music play application has already been executed. Then, when the user writes down the title of an intended song, ‘Yeosu Night Sea’ on the screen, the user terminal plays a sound source corresponding to ‘Yeosu Night Sea’ in the active application.

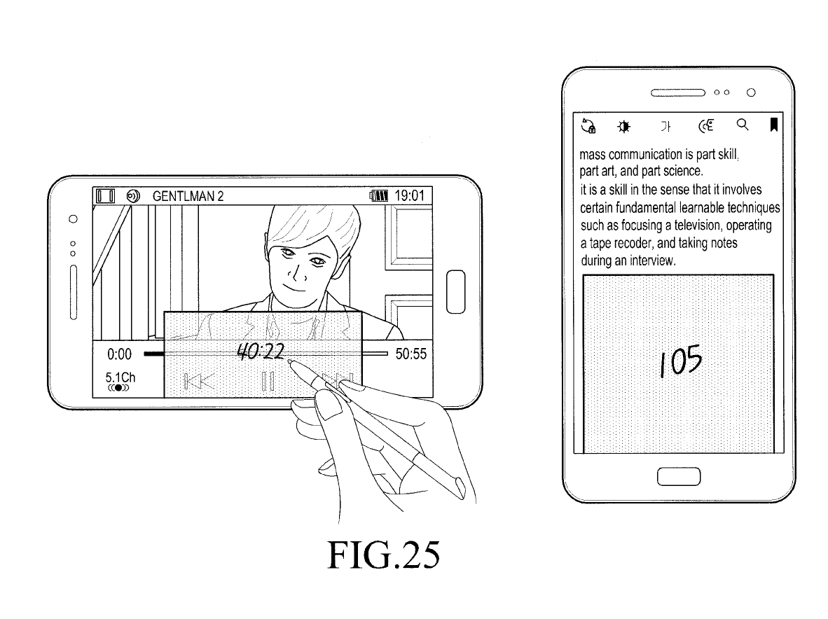

FIG. 25 illustrates exemplary scenarios of controlling a specific active application by the memo function at the user terminal according to an exemplary embodiment of the present invention.

Referring to FIG. 25, if the user writes down a time to jump to, ‘40:22’ on a memo layer during viewing a video, the user terminal jumps to a time point of 40 minutes 22 seconds to play the on-going video. This function may be performed in the same manner during listening to music as well as during viewing a video.

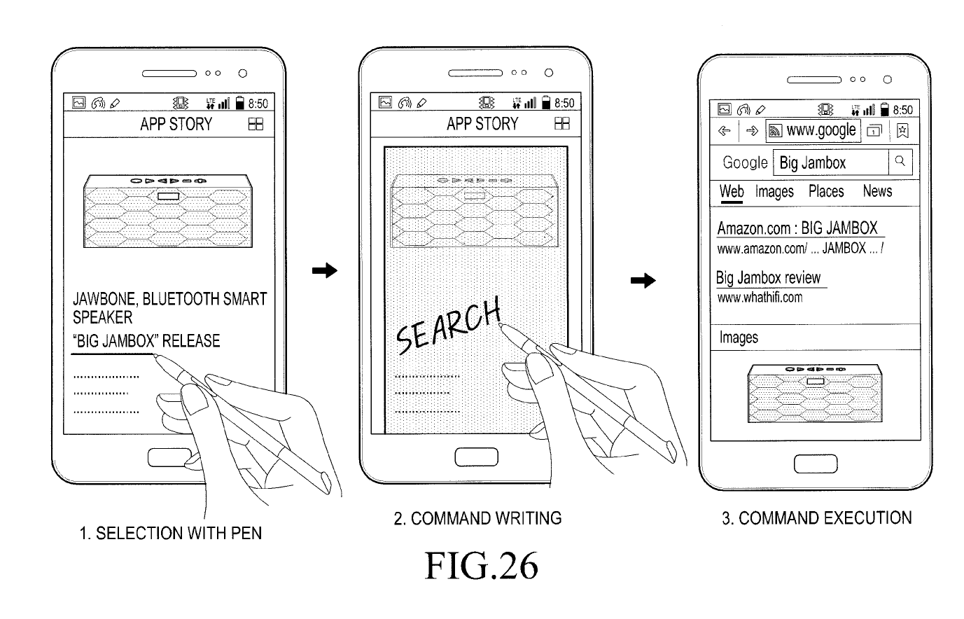

FIG. 26 illustrates a scenario of attempting a search using the memo function, while a Web browser is being executed at the user terminal according to an exemplary embodiment of the present invention.

Referring to FIG. 26, while reading a specific Web page using a Web browser, the user selects a part of content displayed on a screen, launches a memo layer, and then writes down a word ‘search’ on the memo layer, thereby commanding a search using the selected content as a keyword. The NLI engine recognizes the user's intention and understands the selected content through a natural language process. Then the NLI engine performs the search using a set search engine and the selected content and displays the search results on the screen.

As described above, the user terminal may process selection and memo function-based information input together on a screen that provides a specific application.

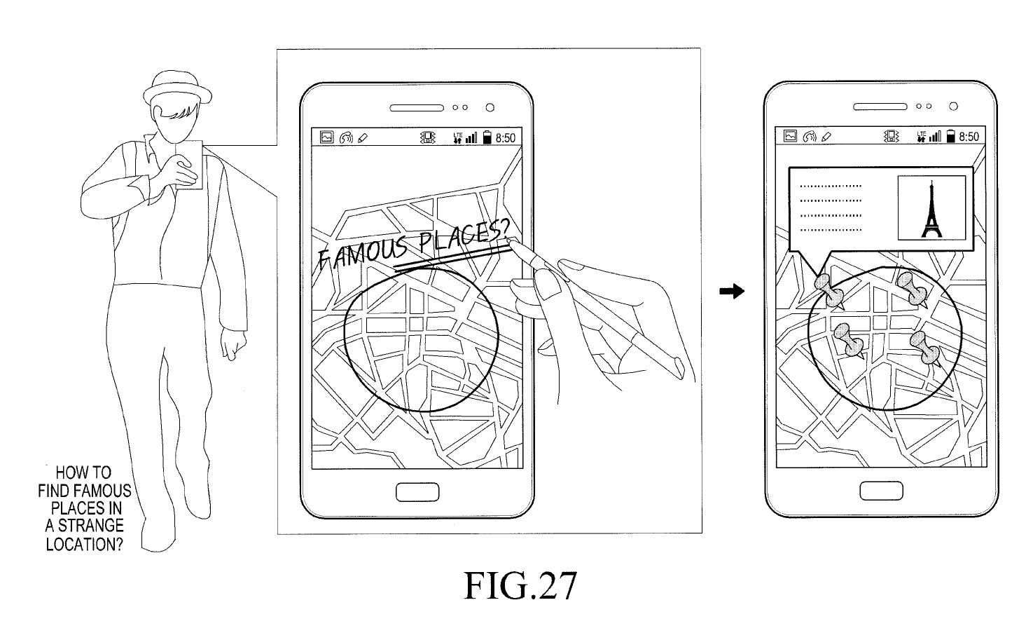

FIG. 27 illustrates a scenario of acquiring intended information in a map application by the memo function according to an exemplary embodiment of the present invention.

Referring to FIG. 27, the user selects a specific area by drawing a closed loop around the area on a screen of a map application using the memo function and writes down information to search for, for example, ‘famous place?’, thereby commanding search for famous places within the selected area.

When recognizing the user's intention, the NLI engine searches for useful information in the NLI engine's database or a database of a server and additionally displays detected information on the map displayed on the current screen.

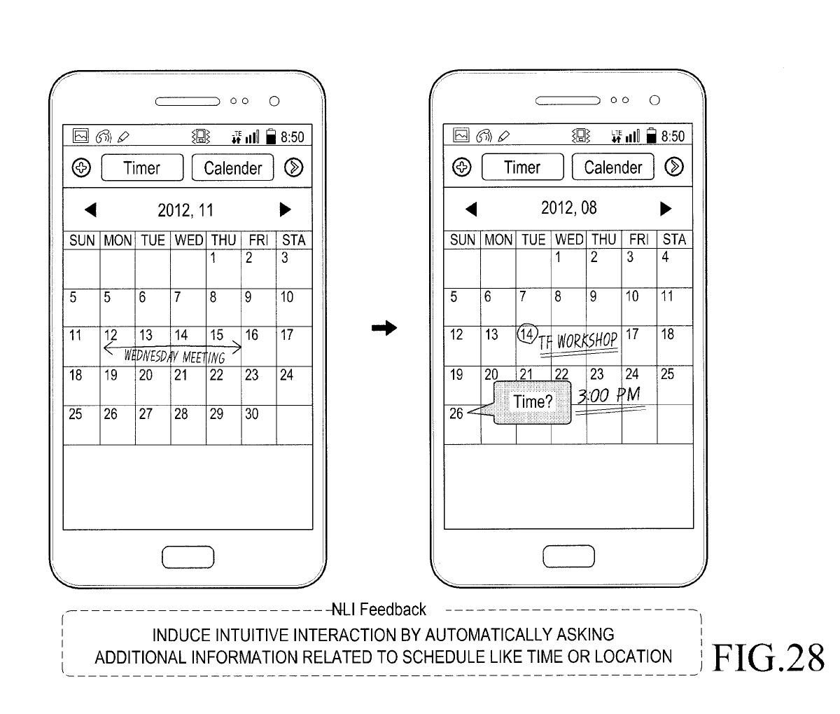

FIG. 28 illustrates a scenario of inputting intended information by the memo function, while a schedule application is being activated according to an exemplary embodiment of the present invention.

Referring to FIG. 28, while the schedule application is being activated, the user executes the memo function and writes down information on a screen, as is done offline intuitively. For example, the user selects a specific date by drawing a closed loop on a schedule screen and writes down a plan for the date. The user selects Aug. 14, 2012 and writes down ‘TF workshop’ for the date. Then the NLI engine of the user terminal requests input of time as additional information. For example, the NLI engine displays a question ‘Time?’ on the screen so as to prompt the user to write down an accurate time such as ‘3:00 PM’ by the memo function.

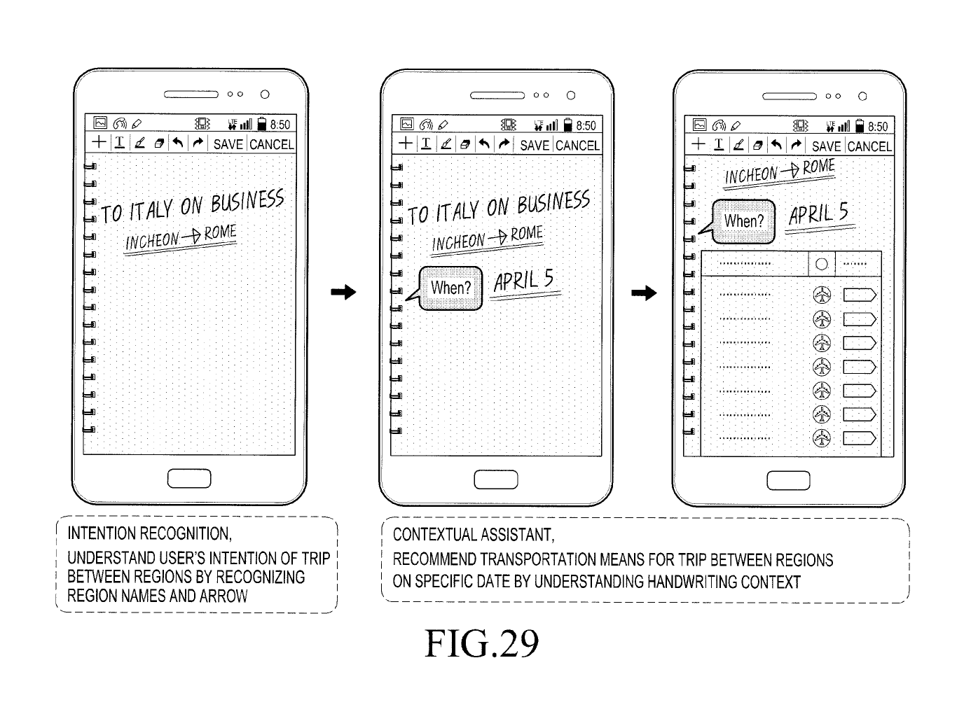

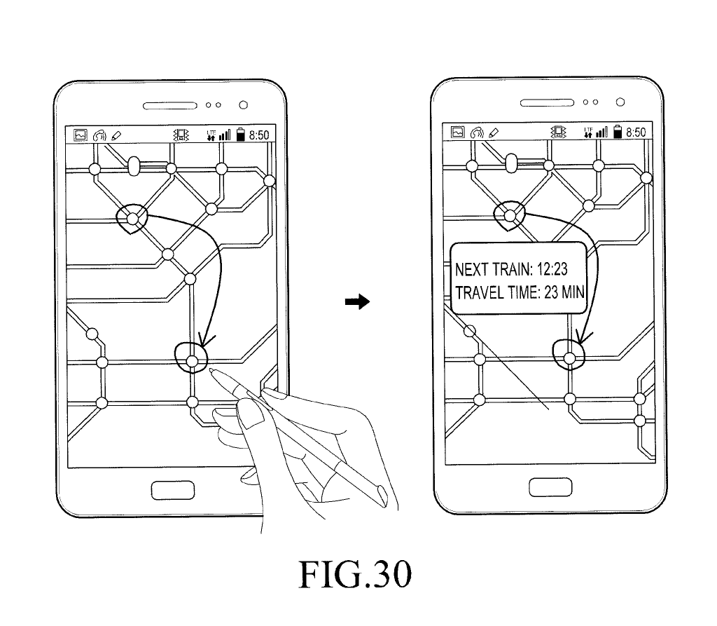

FIGS. 29 and 30 illustrate exemplary scenarios related to semiotics according to an exemplary embodiment of the present invention.

FIG. 29 illustrates an example of interpreting a meaning of a handwritten symbol in the context of a question and answer flow made by a memo function according to an exemplary embodiment of the present invention.

Referring to FIG. 29, in the example illustrated, two notes ‘to Italy on business’ and ‘Incheon→Rome’ are written. Since the symbol → may be interpreted as trip from one place to another, the NLI engine of the user terminal outputs a question asking time, for example, ‘When?’ to the user.

Further, the NLI engine may search for information about flights available for the trip from Incheon to Rome on a user-written date, (e.g., April 5), and provide search results to the user.

FIG. 30 illustrates an example of interpreting the meaning of a symbol written by the memo function in conjunction with an activated application according to an exemplary embodiment of the present invention.

Referring to FIG. 30, when the user selects a departure and a destination using a symbol, that is, an arrow in an intuitive manner on a screen on which a subway application is being activated. Then the user terminal may provide information about the arrival time of a train heading for the destination and a time taken to reach the destination by the currently activated application.

As is apparent from the above description, exemplary embodiments of the present invention can increase user convenience by supporting a memo function in various applications and thus controlling the applications in an intuitive manner.

The above-described scenarios are characterized in that when a user launches a memo layer on a screen and writes down information on the memo layer, the user terminal recognizes the information and performs an operation corresponding to the information. For this purpose, it will be preferred to additionally specify a technique for launching a memo layer on a screen.

For example, the memo layer may be launched on a current screen by pressing a menu button, inputting a specific gesture, keeping a button of a touch pen pressed, or scrolling up or down the screen by a finger. While a screen is scrolled up to launch a memo layer according to an exemplary embodiment of the present invention, many other techniques are available.

It will be understood that the exemplary embodiments of the present invention can be implemented in hardware, software, or a combination thereof. The software may be stored in a volatile or non-volatile memory device like a ROM irrespective of whether data is erasable or rewritable, in a memory like a RAM, a memory chip, a device, or an integrated circuit, or in a storage medium to which data can be recorded optically or magnetically and from which data can be read by a machine (e.g. a computer), such as a CD, a DVD, a magnetic disk, or a magnetic tape.

Further, the UI apparatus and method in the user terminal of the present invention can be implemented in a computer or portable terminal that has a controller and a memory, and the memory is an example of a machine-readable (computer-readable) storage medium suitable for storing a program or programs including commands to implement the exemplary embodiments of the present invention. Accordingly, the present invention includes a program having a code for implementing the apparatuses or methods defined by the claims and a non-transitory storage medium readable by a machine that stores the program.

The UI apparatus and method in the user terminal can receive the program from a program providing device connected by cable or wirelessly and store the program. The program providing device may include a program including commands to implement the exemplary embodiments of the present invention, a memory for storing information required for the exemplary embodiments of the present invention, a communication module for communicating with the UI apparatus by cable or wirelessly, and a controller for transmitting the program to the UI apparatus automatically or upon request of the UI apparatus.

For example, according to exemplary embodiments of the present invention, a recognition engine configuring a UI analyzes a user's intention based on a recognized result and provides the result of processing an input based on the user intention to a user and these functions are processed within a user terminal.

However, it may be further contemplated that the user executes functions required to implement the present invention in conjunction with a server accessible through a network. For example, the user terminal transmits a recognized result of the recognition engine to the server through the network. Then the server assesses the user's intention based on the received recognized result and provides the user's intention to the user terminal. If additional information is needed to assess the user's intention or process the user's intention, the server may receive the additional information by a question and answer procedure with the user terminal.

In addition, the user may limit the operations of exemplary embodiments of the present invention to the user terminal or may selectively extend the operations of the present invention to interworking with the server through the network by adjusting settings of the user terminal.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A User Interface (UI) method in a user terminal, comprising:
invoking a memo layer upon user request to display a memo screen while executing an application;
receiving a pen input event according to a pen input applied on the displayed memo screen by a user;
recognizing pen input contents according to the pen input event;
determining a command related to the application by a natural language process on the recognized pen input contents; and
performing a function of the application related to the determined command.

2. The UI method of claim 1, further comprising:
determining information corresponding to user's intention by the natural language process,
wherein the determining information corresponding to user's intention by the natural language process comprises, if an area is selected and an input is recognized, determining, by the natural language process on the selected area and the input, the command.

3. The UI method of claim 1, wherein the recognition of the pen input contents comprises:
receiving coordinates of points touched on the memo screen by a pen;
storing the coordinates of the touched points as strokes;
generating a stroke array using the strokes; and
recognizing the pen input contents using a pre-stored handwriting library and a stroke array list including the generated stroke array.

4. The UI method of claim 2, wherein the input is predefined, the predefined input corresponds to at least one of a preset symbol, pattern, text, and combination of the symbol, pattern, and text, or at least one gesture preset by a gesture recognition function.

5. The UI method of claim 2, wherein the determining the command comprises:
determining whether the input is included in a pre-stored synonym table;
reading, in the presence of a synonym matching to the command, the an Identifier (ID) value corresponding to the synonym;
executing a method corresponding to the ID value from a predetermined method table; and
executing the application corresponding to the command and transmitting the note contents to the application by the method.

6. The UI method of claim 1, further comprising storing the pen input contents and information about the executed application as a note.

7. The UI method of claim 6, wherein the reception of a pen input on a memo screen from a user further comprises:
retrieving a pre-stored note upon user request and displaying handwritten contents of the retrieved note and information about an already executed application for the retrieved note on the memo screen; and
receiving a pen input event editing the handwritten contents of the retrieved note from the user.

8. The UI method of claim 7, further comprising re-executing the already executed application, upon receipt of a request for re-execution of the already executed application from the user.

9. The UI method of claim 1, wherein the application is a sending application, a search application, a save application or a translation application and the execution of an application comprises receiving the note contents as an input data for the sending application, the search application, the save application or the translation application and sending, performing a search, storing or translating the note contents.

10. A User Interface (UI) apparatus at a user terminal, comprising:
a touch screen configured to:
invoke a memo layer upon user request to display a memo screen, and
output a pen input event according to a pen input applied on the memo screen by a user while executing an application;
one or more processors configured to:
recognize pen input contents according to the pen input event,
determine a command related to the application by a natural language process on the recognized pen input contents, and
perform a function of the application related to the determined command.

11. The UI apparatus of claim 10,
if an area is selected and an input is recognized, the one or more processor determines, by the natural language process on the selected area and the input, command.

12. A User Interface (UI) apparatus at a user terminal, comprising:
a touch screen configured to display a memo screen; and
a controller configured to:
display the memo screen while executing an application on the touch screen and receive and display a first handwriting image,
determine a first information related to the application by a natural language process on the first handwriting image,
display text asking for additional information in response to the first information and receive and display a second handwriting image in response to the text,
determine a second information related to the application by the natural language process on the second handwriting image, and
execute a function of the application based on the first information and the second information,
wherein each of the receiving and displaying of the first handwriting image, the displaying of the text asking for the additional information, and the receiving and displaying of the second handwriting image occur in sequence in a next open area of the touch screen.

13. The UI apparatus of claim 12,
wherein the text asking for additional information is displayed under a position of the first handwriting image displayed on the touch screen, and
wherein the text asking for additional information is displayed in the form of a speech balloon.

14. A User Interface (UI) apparatus at a user terminal, comprising:
a touch screen configured to display a memo screen; and
a controller configured to:
display the memo screen while executing an application on the touch screen and receive and display a first handwriting image,
determine a search request related to the application by a natural language process on the first handwriting image,
display text asking for additional information required to the search request and receive and display a second handwriting image on the touch screen in response to the text,
determine a second information related to the application by the natural language process on the second handwriting image, and
execute search function of the application based on the first information and the second information,
wherein each of the receiving and displaying of the first handwriting image, the displaying of the text asking for the additional information, and the receiving and displaying of the second handwriting image occur in sequence in a next open area of the touch screen.

15. The UI apparatus of claim 14,
wherein, the controller is further configured to, when the reception of a first handwriting image occurs:
receive a user-selected word being a part of contents displayed on the memo screen, as a search keyword, and
receive a command asking a meaning of the selected word,
wherein the text asking for additional information required to the search request is displayed under a position of the first handwriting image displayed on the touch screen, and
wherein the text asking for additional information required to the search request is displayed in the form of a speech balloon, and
wherein the controller stores the first handwriting image and the second handwriting image and the text asking for additional information and information about the function of the application as a note.
